(19) United States
(12) Patent Application Publication
(10) Pub. No.: US 2026/0335891 A1
(43) Pub. Date: Oct. 29, 2026

(54) SYSTEMS, METHODS, AND APPARATUS FOR MICROWEIR FOCUSING AND POSITIONING OF A SAMPLE IN A MICROFLUIDIC CHIP

(71) Applicant: ABS Global, Inc., DeForest, WI (US)

(72) Inventors: Wujun Zhao, Waunakee, WI (US); Zheng Xia, Middleton, WI (US); Daniel McAda, Madison, WI (US); Gary Klas, Madison, WI (US)

(73) Assignee: ABS Global, Inc., DeForest, WI (US)

(21) Appl. No.: 19/490,324

(22) PCT Filed: Jun. 5, 2024
(86) PCT No.: PCT/US2024/032528

§ 371 Date: Dec. 4, 2025

Related U.S. Application Data
(60) Provisional application No. 63/506,522, filed on Jun. 6, 2023.

(51) Int. Cl. B01L 3/00

(52) U.S. Cl. CPC B01L 3/502746; B01L 3/502761; B01L 2200/0636; B01L 2200/0647; B01L 2400/086

(57) ABSTRACT

What is provided is a microweir structure or a set of one or more microweir structures disposed in a microfluidic flow channel, such as a channel in one or more substrate layers of a microfluidic chip. The microweir structure or set of microweir structures orient particles suspended in a sample fluid stream in the microfluidic flow channel, or focus a sample stream which is in laminar flow with a buffer fluid stream in the microfluidic flow channel. A set of one or more lower pressure zones or vortices downstream of a microweir structure contribute to the focusing and orientation effects of the microweir structures.

### CROSS-REFERENCE AND CLAIM OF PRIORITY

This patent application claims the benefit of and priority to U.S. Provisional Patent Application No. 63/506,522, filed Jun. 6, 2023, which is incorporated herein by reference in its entirety.

### FIELD OF THE INVENTION

The present disclosure relates generally to microfluidic chips, and more specifically, to a microfluidic system and method for optimized focusing and orientation of particles within a microchannel of the microfluidic system. Microfluidic devices and methods for focusing particles in a fluid sample are described herein.

### BACKGROUND

In the separation of various particles or cellular materials—for example, the separation of sperm into viable and motile sperm from non-viable or non-motile sperm, or separation by gender—the process is often a time-consuming task, with severe volume restrictions. Thus, current separation techniques cannot, for example, produce the desired yield, or process volumes of cellular materials in a timely fashion.

Photo-damaging laser systems have utilized lasers to photodamage or kill undesired cellular objects. However, the prior art has required flow cytometers using nozzles, to interrogate and arrange the individual objects in droplet flow, and to attempt to separate and photodamage the objects as they fall into various containers—which has been difficult to achieve.

Thus, there exists a present need for a method and apparatus which identifies and discriminates between target objects, is continuous, has high throughput, is time and cost-effective, and causes negligible or minimal damage to the various target objects. In addition, such an apparatus and method should have further applicability to other biological and medical areas, not just in sperm discrimination, but in the discrimination of blood and other cellular materials, including viral, cell organelle, globular structures, colloidal suspensions, and other biological materials.

A wide range of devices has been introduced for microfluidic sorting of cells and/or microparticles. Specifically, it is often desired to separate various particles or cells from the sample fluid mixture, such as the separation of viable and motile sperm from non-viable and non-motile sperm or the separation of sperm by gender. Precise manipulation of particle position inside microscale flow enables highly efficient sorting of particles, if differential markers exist. Specifically, spatial differentiation of particles or cells can be achieved by taking advantage of hydrodynamic forces due to the physical structure of the microfluidic channel or the intense interaction between particles suspended in flow.

Microfluidics enables the use of small volumes for preparing and processing samples, such as various particles or cellular materials. When separating a sample, such as the separation of sperm into viable and motile sperm from non-viable or non-motile sperm, or separation by gender, the process is often a time-consuming task and can have severe volume restrictions. Current separation techniques cannot, for example, produce the desired yield, or process volumes of cellular materials in a timely fashion. Furthermore, existing microfluidic devices do not effectively focus or orient the sperm cells.

Hence, there is need for a microfluidic device and separation process utilizing said device that is continuous, has high throughput, provides time saving, and causes negligible or minimal damage to the various particles of the sample. In addition, such a device and method can have further applicability to biological and medical areas, not just in sperm sorting, but in the separation of blood and other cellular materials, including viral, cell organelle, globular structures, colloidal suspensions, and other biological materials.

### SUMMARY OF THE INVENTION

What is provided are microfluidic channel structures for use in microfluidic chips and flow cytometry systems which provide for the focusing of a sample fluid stream. A set of one or more microweir structures are used to position and focus a sample stream flowing through a microfluidic flow channel such that particles within the sample stream may be interrogated, discriminated, and acted upon at a one or more points in the flow channel.

In accordance with the principles of the present disclosure, a set of one or more curvilinear microweir structures are positioned downstream of an intersection of a sample fluid stream and a sheath or buffer fluid stream to focus the sample fluid stream within the sheath or buffer fluid stream. The size, number, and geometry of the microweir structures may be set to determine the focusing and flow characteristics of the sample fluid stream within a microfluidic channel structure in a substrate of a microfluidic chip. The microfluidic chip may be used as part of a flow cytometer or other microfluidic instrument to act as the means for flowing a focusing a sample stream therethrough.

Provided herein are systems and methods for the focusing of a sample fluid in a microfluidic chip for the interrogation, analysis, and action on the sample fluid.

In one embodiment, what is provided is a microweir structure for focusing a sample stream in a microfluidic chip, the microweir structure comprising: a curvilinear structure extending widthwise across a flow channel and extending upwards from a bottom surface of the flow channel without contacting a top surface of the flow channel and without completely obstructing the flow channel.

In various embodiments, a portion of the flow channel is 75 to 150 microns in width and 75 to 200 microns in height.

In various embodiments, a portion of the flow channel is 135 microns in width and 150 microns in height.

In various embodiments, a distance between a top of the curvilinear structure and the top surface of the flow channel is 40 to 75 microns.

In various embodiments, a distance between the top of the curvilinear structure and the top surface of the flow channel is 54.5 microns.

In various embodiments, a distance between the top of the curvilinear structure and the top surface of the flow channel is 47 microns.

In various embodiments, a distance between the top of the curvilinear structure and the top surface of the flow channel is 56.5 microns.

In various embodiments, a height of the curvilinear structure is 75 to 125 microns.

In various embodiments, the height of the curvilinear structure is 95.5 microns.

In various embodiments, the height of the curvilinear structure is 93.5 microns.

In various embodiments, the height of the curvilinear structure is 103 microns.

In various embodiments, the curvilinear structure is disposed in an interrogation region of the flow channel.

In various embodiments, the curvilinear structure is configured to focus a sample stream.

In various embodiments, the curvilinear structure is configured to orient particles suspended in a sample stream.

In various embodiments, the curvilinear structure comprises a set of curvilinear structures.

In various embodiments, an interrogation location is disposed between a first and a second curvilinear structure in the set of curvilinear structures.

In various embodiments, the first curvilinear structure in the set of curvilinear structures comprises an upstream curved portion, a top curved portion, and a downstream curved portion, and wherein the second curvilinear structure comprises only an upstream curved portion and a flat top portion.

In various embodiments, a distance between the first and the second curvilinear structures is between 300 and 500 microns.

In various embodiments, a distance between the first and the second curvilinear structures is 389 microns.

In various embodiments, a distance between the first and the second curvilinear structures is 407 microns.

In another embodiment, what is provided is a microweir structure for focusing a sample stream in a microfluidic chip, the microweir structure comprising: a substantially sinusoidal-shaped structure extending across a width of a flow channel, the substantially sinusoidal-shaped structure having an ascending portion, an apex, and a descending portion, the ascending portion extending upwardly from a bottom surface of the flow channel to the apex, the apex disposed at a point below a top surface of the flow channel, and the descending portion extending downwardly from the apex to the bottom surface of the flow channel, wherein a vertex defining the starting position of the ascending portion and a vertex defining an ending position of the descending portion are disposed on a same plane.

In another embodiment, what is provided is a microweir structure for focusing a sample stream in a microfluidic chip, the microweir structure comprising: a substantially derivative sigmoid-shaped structure extending across a width of a flow channel, the substantially derivative sigmoid-shaped structure having an ascending portion, an apex, and a descending portion, the ascending portion extending upwardly from a bottom surface of the flow channel to the apex, the apex disposed at a point below a top surface of the flow channel, and the descending portion extending downwardly from the apex to the bottom surface of the flow channel, wherein a vertex defining the starting position of the ascending portion and a vertex defining an ending position of the descending portion are disposed on a same plane.

In another embodiment, what is provided is a microweir structure for focusing a sample stream in a microfluidic chip, the microweir structure comprising: a curved structure disposed on a bottom surface of a flow channel, wherein the structure extends from a first side to a second side of the flow channel and upwardly from a bottom surface of the flow channel, and wherein a shape of the curved structure at a longitudinal cross-section is defined by the formula

$$y = \frac{1}{\sqrt[σ]{2 π}} {e}^{- \frac{{( x - μ )}^{2}}{2 {σ}^{2}}} .$$

In another embodiment, what is provided is a microweir structure for focusing a sample stream in a microfluidic chip, the microweir structure comprising: a curved structure disposed on a bottom surface of a flow channel, wherein the structure extends from a first side to a second side of the flow channel and upwardly from a bottom surface of the flow channel, and wherein a shape of the curved structure at a longitudinal cross-section is defined by the formula y=e^{-x}^{²}.

In another embodiment, what is provided is a microweir structure for focusing a sample stream in a microfluidic chip, the microweir structure comprising: a curved structure disposed on a bottom surface of a flow channel, wherein the structure extends from a first side to a second side of the flow channel and upwardly from a bottom surface of the flow channel, and wherein a shape of the curved structure at a longitudinal cross-section is defined by the formula

$$\frac{{e}^{- x}}{{( 1 + {e}^{- x} )}^{2}} .$$

In another embodiment, what is provided is a microweir structure for focusing a sample stream in a microfluidic chip, the microweir structure comprising: a curved structure disposed on a bottom surface of a flow channel, wherein the structure extends from a first side to a second side of the flow channel and upwardly from a bottom surface of the flow channel; wherein a curvature of an upstream surface of the curved structure is defined by a circle having a diameter of between 206 and 303 microns, a curvature of a downstream surface of the curved structure is defined by a circle having a diameter of between 206 and 303 microns, and a top of the curved structure disposed between the upstream surface and the downstream surface is a curved surface defined by a circle having a radius of 8 microns; and wherein a height of the curved structure is between 70 and 110 microns.

In another embodiment, what is provided is a method of focusing a sample fluid stream in a microfluidic channel comprising: introducing the sample fluid stream in a flow channel; introducing a sheath fluid stream in the flow channel and surrounding the sample fluid stream in the sheath fluid stream; flowing the sample fluid stream over a microweir structure, wherein the sample fluid stream is focused vertically in at least one direction by flowing over the microweir structure, and wherein a flow vortex downstream of the microweir structure maintains focusing of the sample stream downstream of the microweir structure.

In various embodiments, a portion of the flow channel is 75 to 150 microns in width and 75 to 200 microns in height

In various embodiments, a portion of the flow channel is 135 microns in width and 150 microns in height

In various embodiments, a distance between a top of the microweir structure and the top surface of the flow channel is 40 to 75 microns.

In various embodiments, a distance between the top of the microweir structure and the top surface of the flow channel is 54.5 microns.

In various embodiments, a distance between the top of the microweir structure and the top surface of the flow channel is 47 microns.

In various embodiments, a distance between the top of the microweir structure and the top surface of the flow channel is 56.5 microns.

In various embodiments, a height of the microweir structure is 75 to 125 microns.

In various embodiments, the height of the microweir structure is 95.5 microns.

In various embodiments, the height of the microweir structure is 93.5 microns.

In various embodiments, the height of the microweir structure is 103 microns.

In various embodiments, the microweir structure is disposed in an interrogation region of the flow channel.

In various embodiments, the microweir structure is configured to focus a sample stream.

In various embodiments, the microweir structure is configured to orient particles suspended in a sample stream.

In various embodiments, the microweir structure comprises a set of microweir structures.

In various embodiments, an interrogation location is disposed between a first and a second microweir structure in the set of microweir structures.

In various embodiments, the first microweir structure in the set of microweir structures comprises an upstream curved portion, a top curved portion, and a downstream curved portion, and wherein the second microweir structure comprises only an upstream curved portion and a flat top portion.

In various embodiments, a distance between the first and the second microweir structures is between 300 and 500 microns.

In various embodiments, a distance between the first and the second microweir structures is 389 microns.

In various embodiments, a distance between the first and the second microweir structures is 407 microns.

In another embodiment, what is provided is a set of microweir structures for focusing a sample stream in a microfluidic chip, the set of microweir structures comprising: a first microweir structure comprising a substantially sinusoidal-shaped structure extending across a width of a flow channel, the ramp structure having an ascending portion, an apex, and a descending portion, the ascending portion extending upwardly from a bottom surface of the flow channel to the apex, the apex disposed at a point below a top surface of the flow channel, and the descending portion extending downwardly from the apex to the bottom surface of the flow channel, wherein a vertex defining the starting position of the ascending portion and a vertex defining an ending position of the descending portion are disposed on a same plane; and a second microweir structure comprising a substantially sinusoidal-shaped structure extending across a width of a flow channel, the ramp structure having an ascending portion, an apex, and a descending portion, the ascending portion extending upwardly from a bottom surface of the flow channel to the apex, the apex disposed at a point below a top surface of the flow channel, and the descending portion extending downwardly from the apex to the bottom surface of the flow channel, wherein a vertex defining the starting position of the ascending portion and a vertex defining an ending position of the descending portion are disposed on a same plane.

In another embodiment, what is provided is a microfluidic channel structure comprising: a sheath fluid channel; a sample fluid channel; an intersection; and a flow channel comprising at least one microweir structure, the microweir structure comprising a curvilinear structure extending widthwise across the flow channel and extending upwards from a bottom surface of the flow channel without contacting a top surface of the flow channel and without completely obstructing the flow channel; wherein the sample fluid channel and the sheath fluid channel are substantially disposed upstream of the intersection and intersect at the intersection; and wherein the flow channel is disposed substantially downstream of the intersection.

In another embodiment, what is provided is a microfluidic chip comprising: a microfluidic channel structure, the microfluidic channel structure comprising a curvilinear structure extending widthwise across a flow channel in the microfluidic chip and extending upwards from a bottom surface of the flow channel without contacting a top surface of the flow channel and without completely obstructing the flow channel.

In another embodiment, what is provided is a system for differentiating particles in a sample stream, the system comprising: an interrogation means; a detection means; and a microfluidic chip comprising a microfluidic channel structure, the microfluidic channel structure comprising a curvilinear structure extending widthwise across a flow channel in the microfluidic chip and extending upwards from a bottom surface of the flow channel without contacting a top surface of the flow channel and without completely obstructing the flow channel, the curvilinear structure configured to focus a sample stream in the microfluidic channel for interrogation and detection by the respective detection means and interrogation means.

In another embodiment, what is provided is a method of focusing a sample stream, the method comprising: providing a sample stream in a microfluidic channel structure of a microfluidic chip; providing a buffer fluid stream in the microfluidic channel structure of the microfluidic chip; flowing the sample fluid stream and the buffer fluid stream through the microfluidic channel structure of the microfluidic chip in a laminar flow to an interrogation region; and prior to the interrogation region, focusing the sample fluid stream by at least one microweir structure.

In another embodiment, what is provided is a method of orienting particles in a sample stream, the method comprising: providing a sample stream in a microfluidic channel structure of a microfluidic chip; providing a buffer fluid stream in the microfluidic channel structure of the microfluidic chip; flowing the sample fluid stream and the buffer fluid stream through the microfluidic channel structure of the microfluidic chip in a laminar flow to an interrogation region; and prior to the interrogation region, orienting particles suspended in the sample fluid stream by positioning the sample fluid stream near a top surface of the microfluidic channel structure using at least one microweir structure.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention but are intended to be exemplary and for reference.

FIG. 1 provides a plan view of a microfluidic channel structure according to one embodiment.

FIG. 1A provides a plan view of a microfluidic channel structure according to one embodiment.

FIG. 2 provides a view of an interrogation region of a microfluidic channel structure according to one embodiment.

FIG. 3 provides a lateral cross-section view of an interrogation region of a microfluidic channel structure comprising a set of microweir structures according to one embodiment.

FIG. 4 provides a perspective view of an interrogation region of a microfluidic channel structure comprising a set of microweir structures according to one embodiment.

FIG. 5 provides a top plan view of an interrogation region of a microfluidic channel structure comprising a set of microweir structures according to one embodiment.

FIG. 6 provides a top perspective view of an interrogation region of a microfluidic channel structure comprising a set of microweir structures according to one embodiment.

FIG. 7 provides a set of simulation views of a sample stream and of fluid flow in an interrogation region of a microfluidic channel structure comprising a set of microweir structures according to one embodiment.

FIG. 8 provides a graph of fluid flow velocity and sample stream position at an interrogation location in an interrogation region of a microfluidic channel structure comprising a set of microweir structures according to one embodiment.

FIG. 9 provides a lateral cross-section view of an interrogation region of a microfluidic channel structure comprising a set of microweir structures according to one embodiment.

FIG. 10 provides a perspective view of an interrogation region of a microfluidic channel structure comprising a set of microweir structures according to one embodiment.

FIG. 11 provides a top plan view of an interrogation region of a microfluidic channel structure comprising a set of microweir structures according to one embodiment.

FIG. 12 provides a top perspective view of an interrogation region of a microfluidic channel structure comprising a set of microweir structures according to one embodiment.

FIG. 13 provides a set of simulation views of a sample stream and of fluid flow in an interrogation region of a microfluidic channel structure comprising a set of microweir structures according to one embodiment.

FIG. 14 provides a graph of fluid flow velocity and sample stream position at an interrogation location in an interrogation region of a microfluidic channel structure comprising a set of microweir structures according to one embodiment.

FIG. 15 provides a lateral cross-section view of an interrogation region of a microfluidic channel structure comprising a set of microweir structures according to one embodiment.

FIG. 16 provides a perspective view of an interrogation region of a microfluidic channel structure comprising a set of microweir structures according to one embodiment.

FIG. 17 provides a top plan view of an interrogation region of a microfluidic channel structure comprising a set of microweir structures according to one embodiment.

FIG. 18 provides a top perspective view of an interrogation region of a microfluidic channel structure comprising a set of microweir structures according to one embodiment.

FIG. 19 provides a set of simulation views of a sample stream and of fluid flow in an interrogation region of a microfluidic channel structure comprising a set of microweir structures according to one embodiment.

FIG. 20 provides a graph of fluid flow velocity and sample stream position at an interrogation location in an interrogation region of a microfluidic channel structure comprising a set of microweir structures according to one embodiment.

FIG. 21 provides a lateral cross-section view of an interrogation region of a microfluidic channel structure comprising a set of microweir structures according to one embodiment.

FIG. 22 provides a set of simulation views of a sample stream and of fluid flow in an interrogation region of a microfluidic channel structure comprising a set of microweir structures according to one embodiment.

FIG. 23 provides a graph of fluid flow velocity and sample stream position at an interrogation location in an interrogation region of a microfluidic channel structure comprising a set of microweir structures according to one embodiment.

### DETAILED DESCRIPTION

The systems, apparatuses, and methods herein will now be described in more detail with reference to exemplary embodiments as shown in the accompanying drawings. While the present invention is described herein with reference to the exemplary embodiments, it should be understood that the systems and methods herein are not limited to such exemplary embodiments. Those possessing ordinary skill in the art and having access to the teachings herein will recognize additional implementations, modifications, and embodiments, as well as other applications for use of the invention, which are fully contemplated herein as within the scope of the systems and methods as disclosed and claimed herein, and with respect to which the systems and methods herein could be of significant utility.

As used herein, “action”, such as in an “action region”, refers to a particular effect that is directed to a thing. Such as, for example, an enrichment, sorting, or effect of a decision that diverts, moves, destroys, or inactivates the thing being acted upon. Without limitation, this may be the laser ablation of a particle in a sample stream, the diversion of a particle from a sample stream, or the trapping or suspension of a particle in a sample stream.

As used herein, “focusing” refers to the compression, from at least one side, of one fluid stream by another fluid stream in a laminar fluid flow regime in a microfluidic environment especially where particles in or suspended in the first fluid stream are ordered, oriented or aligned with respect to a defined plane or surface, or “focusing” refers to the ordering, orientation, or alignment of particles within a fluid stream in an inertial microfluidic regime by inertial forces within the fluid stream and microfluidic channel. Focusing may be performed by one or more of a geometric channel feature, a channel length or size, or the introduction of one or more sheath or buffer fluids into a flow channel.

As used herein, “intersection”, which may also be referred to as a “junction”, comprises the joining of any two or more channels within the microfluidic channel structure of a microfluidic chip. For example, and without limitation, an intersection may comprise the location where a sheath fluid channel joins a main flow channel, the location where two or more sheath fluid channels join flow channel, the location where a sheath fluid channel and a sample channel join a flow channel, the location where a sheath fluid channel joins a sample channel, or any combination of the aforementioned examples.

As used herein, “interrogation” refers to the process of probing a thing to reveal one or more characteristics of a thing, such as the identification of a characteristic of a particle. This may be, for example, the identification of a characteristic of a particle by exposing the particle to a light source, such as a laser beam, and detecting one or more light emissions from the particle, such as forward scatter, side scatter, or a Stoke-shifted emission.

As used herein, “laminar flow” refers to a non-mixing flow regime in a microfluidic environment where one or more flow streams flow through a flow channel in a non-mixing manner. Laminar flow may be defined as a flow having a particular stream or particle Reynold's number.

As used herein, “microweir” refers to a curvilinear structure disposed in a microfluidic channel. Specifically, a microweir may be a single structure or part of a set of microweir structures and which is configured or adapted to position a sample fluid stream within a flow channel.

As used herein, “particle” refers to any thing which may be present in a flow stream. For example, a particle may be a polystyrene bead, a magnetic bead, a protein, cellular debris, small inorganic matter, or a cell, such as a sperm cell.

As used herein, “sample fluid” refers to a fluid comprising an analyte to be measured. A sample fluid may be, for example, a fluid mixture comprising a buffer fluid media and a plurality of polystyrene beads, or may be a fluid mixture of sperm cells in seminal plasma, or may be a fluid mixture of sperm cells, with or without seminal plasma, in an other media.

As used herein, “sheath fluid” or “buffer fluid” refers to a fluid which provides sheath flow and/or hydrodynamic focusing of a sample fluid in a microfluidic environment in laminar flow conditions.

As used herein, “structure” is an element or collection of elements of a physical thing. For example, a sheath fluid structure may comprise one or more sheath fluid channels and all elements or components of the sheath fluid channels. For example, a microfluidic channel structure may comprise all elements therein, such as sample fluid channels, flow channels, sheath fluid channels, and outlet channels. A structure may comprise one or more other structures.

As used herein, “set” refers to a collection or grouping of one or more things, especially similar, associated, or related things, and which does not refer to a null set or null collection unless explicitly specified.

While structures, channels, and other features herein may be referred to as a “first” or a “second” structure or feature, this is for reference only, and the structures or features may also be considered to be a “top” and a “bottom”, a “left side” and a “right side”, “corresponding”, or “opposing” structures unless a particular structural or spatial arrangement is explicitly indicated as necessary for function or operation.

Generally, a microfluidic system having a microfluidic chip with a microchannel comprising at least one microweir structure is disclosed. In one example, the microfluidic system includes at least one detection means, such as a detection site or any other detection means. The microfluidic chip may be used with the as least one detection means. The microchannel is configured to receive fluid having particles. The geometry of sections of the microchannel—specifically of at least one microweir structure or of a set of microweir structures, the flow of a buffer or sheath fluid, and a pressure and flow rate of the fluid through the microchannel optimize focusing and orientation of the particles within the microchannel, orienting the particles.

In one embodiment, the present invention relates to a microfluidic chip with an interrogation apparatus that detects and interrogates objects in a sample fluid mixture. In another embodiment, the present invention relates to a microfluidic chip with an interrogation apparatus that detects and interrogates objects in a sample fluid mixture, and a focused energy apparatus that performs an action on the objects or a region around the objects. In one embodiment, the interrogation apparatus interrogates the objects to identify the objects and to determine whether the objects should be targeted by the focused energy apparatus. In one embodiment, the targeted objects are unwanted targeted objects.

In one embodiment, the focused energy apparatus is a discrimination apparatus that discriminates between targeted and non-targeted objects by damaging, killing, altering, disabling, or destroying the targeted objects. The present invention is conducted in a flowing, continuous fluid stream within the microfluidic network, where objects are subject to hydrodynamic focusing, positioning, and orientation, and non-targeted objects are allowed to flow through the microfluidic chip undisturbed, and targeted objects may be acted upon, including photodamaged, killed, altered, disabled, or destroyed, by a focused energy apparatus, or sorted or separated by a separating means such as a jet sorter, fluid sorter, piezoelectric sorter, or similar mechanical sorting means.

The various embodiments of the present disclosure provide for the selection of objects in a fluid mixture, such as, for example: selecting viable or motile sperm from non-viable or non-motile sperm; selecting sperm by gender, and other sex selection variations; selecting stems cells from cells in a population; selecting one or more labeled cells from un-labeled cells distinguishing desirable/undesirable traits; selecting cells for desirable characteristics; selecting genes in nuclear DNA in cells, according to a specified characteristic; selecting cells based on surface markers; selecting cells based on membrane integrity (viability), potential or predicted reproductive status (fertility), ability to survive freezing, etc.; selecting cells from contaminants or debris; selecting healthy cells from damaged cells (i.e., cancerous cells) (as in bone marrow extractions); red blood cells from white blood cells and platelets in a plasma mixture; and selecting any cells from any other cellular objects, into corresponding fractions; selecting damaged cells, or contaminants or debris, or any other biological materials that are desired to discriminated. The objects may be cells or beads treated or coated with linker molecules or embedded with a fluorescent or luminescent label molecule(s). The objects may have a variety of physical or chemical attributes, such as size, shape, materials, texture, etc.

In one embodiment, a heterogeneous population of objects may be measured, with each object being examined for different quantities or regimes in similar quantities (e.g., multiplexed measurements), or the objects may be examined and distinguished based on a label (e.g., fluorescent), image (due to size, shape, different absorption, scattering, fluorescence, luminescence characteristics, fluorescence or luminescence emission profiles, fluorescent or luminescent decay lifetime), and/or particle position, etc.

In addition, the subject matter of the present disclosure is also suitable for other medical applications as well. For example, the various laminar flows discussed below may be utilized as part of a kidney dialysis process, in which whole blood is cleansed of waste products and returned to the patient. Further, the various embodiments of the present disclosure may have further applicability to other biological or medical areas, such as for selection of cells, viruses, bacteria, cellular organelles or subparts, globular structures, colloidal suspensions, lipids and lipid globules, gels, immiscible particles, blastomeres, aggregations of cells, microorganisms, and other biological materials. For example, the object selection in accordance with the present disclosure may include cell “washing”, in which contaminants (such as bacteria) are removed from cellular suspensions, which may be particularly useful in medical and food industry applications. Further, the present invention has the applicability to select non-motile cellular objects from motile cellular objects.

The action of selecting species may rely on a number of physical properties of the objects or objects including self-motility, self-diffusivity, free-fall velocity, or action under an external force, such as an actuator, an electromagnetic field, or a holographic optical trap. The properties which may be selected include, for example, cell motility, cell viability, object size, object mass, object density, the tendency of objects to attract or repel one another or other objects in the flow, object charge, object surface chemistry, and the tendency of certain other objects (i.e., molecules) to adhere to the object.

In one embodiment, the optimized focusing and orientation of the particles by the microfluidic chip comprising one or more microweirs of the present disclosure provides for detection by at least one detection means, and the detection comprises a detection of a difference in DNA content in the particles. The difference in DNA content may comprise one or more of: (1) approximately a 4% difference in DNA content; or (2) the presence or the absence of an X/Y chromosome, for example. For example, in some examples, the at least one detection means may include one or more of the following embodiments: (1) detecting cells as being live or dead, and acting on a subset of the live cells based upon a further classification; (2) detecting the presence of an X or Y chromosome in cells, identifying cells comprising a Y chromosome, and acting on the Y chromosome bearing cells; (3) detecting the presence of an X or Y chromosome in cells, identifying cells not comprising an X chromosome, and acting on the not-X cells; (4) detecting the presence of an X or Y chromosome in cells, identifying cells comprising a X chromosome, and acting on the X chromosome bearing cells; and/or (5) detecting the presence of an X or Y chromosome in cells, identifying cells not comprising a Y chromosome, and acting on the not-Y cells. Further, although the above-described example is specific to X/Y chromosome detection, it will be understood that other DNA segments may be used in the systems and methods of the present invention and still fall within the scope of the present disclosure. For example, other DNA segments could be labeled and the same methods used to de-activate sperm cells with undesired traits.

While discussion herein may focus on the identification and selection of viable or motile sperm from non-viable or non-motile sperm, or selecting sperm by gender and other sex selection variations, or selecting one or more labeled cells from un-labeled cells distinguishing desirable/undesirable traits, etc., the apparatus, methods, and systems of the present invention may be extended to other types of particulate, biological or cellular matter, which are capable of being interrogated by fluorescence techniques within a fluid flow, or which are capable of being manipulated between different fluid flows into one or more outputs.

The various embodiments of the microfluidic chip comprising one or more microweirs, as described herein, utilize one or more flow channels, having a set of substantially laminar flows, allowing one or more objects to be interrogated for identification by an interrogation apparatus, and to be acted upon, such as by an actuation or by a focused energy apparatus, with the objects exiting the microfluidic chip via one or more outputs. In one embodiment, the objects not acted upon are undisturbed, and the action diverts, traps, photodamages, alters, disables, kills, or destroys targeted objects.

The various embodiments of the present disclosure thereby provide a selection of objects on a continuous basis, such as, within a continuous, closed system without the potential damage and contamination of prior art methods, particularly as provided in sperm separation. The continuous process of the present disclosure also provides significant time savings in selecting and discriminating objects.

The sheath or buffer fluids are well known in the art of microfluidics, and in one embodiment, may contain nutrients well known in the art to maintain the viability of the objects (i.e., sperm cells) in the fluid mixture. Commercially available Tris, as sold by Chata Biosystems, is one example, and the sheath or buffer fluid 163 may be formulated to include the following: Water—0.9712 L; Tris—23.88 gg; citric acid monohydrate—11.63 g; D-fructose—8.55 g. The pH is adjusted to 6.80±0.05 with hydrochloric acid, and osmolarity is adjusted, if necessary, to 270-276 mOsm with fructose high purity. The mixture is filtered using a 0.22-micron filter.

The microfluidic chip may have one or more structural layers in which the micro-channels are disposed. The channels may be disposed in one or more layers or in-between layers. Any suitable bonding process known by one of ordinary skill in the art would provide for a microfluidic chip, channel, or device as described herein. For example, in injection molding, instead of forming two layers, two molds could be made and joined together, such that an injection is made into the cavity in order to obtain the chip of the present invention. Layers may also be separately etched in glass or another material, such as by chemical, optical, or cutting processes, and joined or bonded together in a proper alignment to form a complete microfluidic chip.

However, one of ordinary skill in the art would know that more or fewer structural layers with functional sides, and with or without “blank” layers, may be used, and the channels may be disposed in any of the structural layers, or in different structural layers, and in any arrangement, with access to those channels through a top “blank” layer, as long as the object of the present invention is achieved.

In conventional flow cytometry systems, such as droplet-in-air flow cytometry systems, since objects or cells, especially with asymmetric shapes, tend to orient as they flow close to a solid surface, the function and improvement of object or cell orientation relies on complex nozzle designs, such as orienting baffles or an offset structure inside the nozzle. To avoid the complex design of nozzle-based flow cytometry systems, and their high fabrication cost, the microfluidic chip and channel design described herein focuses, positions, and orients the particles in order to optimize the analytical capability of a flow cytometry system or apparatus which interrogates and acts upon the particles. Thus, in one embodiment, the particles (i.e., cells which may have or comprise asymmetric or non-spherical shapes) are aligned into a restricted core volume, which may be referred to as a core stream having a width of 2-100 microns and a height of 2-100 microns, in a channel and maintained in a similar and desired orientation as the particles pass through an interrogation region. As a result, more uniform scattering and detection signals is obtained, thus, helping to increase the system's sensitivity and stability.

The design of the microfluidic chip comprising one or more microweirs and the flow cytometry system described herein provides for the core sample stream to orient flat-shaped particles, position the particles in a channel in a physical arrangement approaching uniformity, all of which improves the downstream precision action by a device, such as a focused energy apparatus or jet-sorting fluid actuator, performing an action on the particles.

To realize the exemplary three-dimensional hydrodynamic focusing methods described herein, both sample fluid and sheath or buffer fluids are required to be precisely delivered so that a constant flow can be streamed through the microfluidic chip. After being compressed by the sheath or buffer fluid flows, the particles have been accelerated and the average spacing between the particles in the sample core stream is also stretched significantly therefrom. The ratio of the total sheath or buffer fluid flow rate and the sample flow rate can be adjusted between 100:1 and 1000:1. Preferably, the ratio of 200-400:1 is used in the microfluidic chip and channel structure described herein. The overall fluid flow rate in the microfluidic chip and channel structure is about 2-4 ml/min, 2.5 ml/min, 3 ml/min, 4-6 ml/min, or 1-2 ml/min so long as laminar flow (non-turbulent flow) of the sample stream and the sheath fluid stream is maintained. Specifically, an appropriate flow regime is established when the Reynolds number is below 2000, and may be in the range of 1-1000. The introduced sheath or buffer fluid flows are constant and pulse-free to ensure a stable traveling speed of the particles during interrogation and signal detection, and between the detection/interrogation position in the interrogation region and the position of the action on the particles downstream of the interrogation. This facilitates an accurate signal reading and action on a target particle by, for example, a focused energy apparatus. With the precise control of fluid flow through the main channel (a flow channel), the overall flow rate variation is less than 1% of the set flow rate, and the traveling speed of target particles for potential action varies less than 1% from the position where interrogation and detection of particles takes place, to the position where the particles are acted upon.

One of the challenging issues in the detection of flat-shaped particles (i.e., sperm cells) is to constrain the particles in a uniform orientation when passing through, for example, an interrogation beam of electromagnetic radiation emitted from a laser at an interrogation location within an interrogation region. Thus, an approximately uniform positioning of particles and a corresponding orientation of particles in the flow channel helps to increase the sensitivity of the system. With the focusing strategy described herein provided by one or more microweir structures, the position of particles along the flow channel, specifically at or in an interrogation region of a microfluidic chip, can be manipulated in a controlled way. Thus, by placing or positioning one or more microweirs or microweir structures near or in an interrogation region of a microfluidic chip, a position of the focused sample stream may be offset from the center of the channel by about 5-40 microns (based on a channel cross-section of 150-micron width, and 100-micron heights, for example), such as in an offset position relatively closer to the top surface of the microfluidic channel for orientation purposes, and is preferred for the detection of flat-shaped particles. Generally, an offset of 0-100 microns bias position of the particles can be achieved as either a fixed (e.g., from a physical channel configuration, such as by microweir structures) or adjustable (e.g., from varying the flow rates) offset.

In one embodiment, pancake-shaped, or oar-shaped sperm cells are taken as an example of the particles. Because of their pancake-type or flattened teardrop-shaped heads, the sperm cells will re-orient themselves in a predetermined direction as they undergo focusing—i.e., with their flat surfaces perpendicular to the direction of an interrogation light source. Thus, the sperm cells develop a preference on their body orientation while passing through the hydrodynamic focusing process. Specifically, the sperm cells tend to be more stable with their flat bodies perpendicular to the direction of the compression, with additional orientation achieved based on shear forces associated with a proximity to a surface, such as a top surface of a flow channel. Hence, with the design or control of the channel geometry, such as by using microweir structures, the sperm cells which start with random orientation, now achieve uniform orientation. Thus, the sperm cells are not only disposed in a restricted core volume at the center of the flow channel, but they also achieve a uniform orientation.

The focusing improves the sperm cells' orientation and the capability to differentiate the DNA content of X- and Y-sperm chromosomes (and thereby distinguish between X and Y sperm).

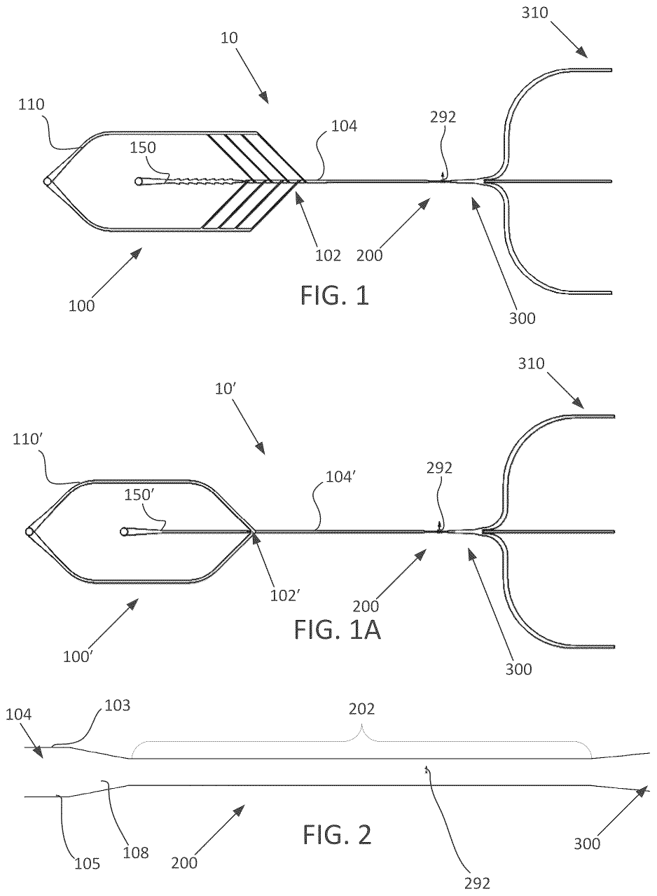

Now, with respect to FIG. 1 and FIG. 1A, what is provided is a microfluidic channel structure 10, 10′ comprising a sheath fluid structure 100, 100′, sample fluid channel 150, 150′, flow channel 104, 104′ (which may also be referred to as a fluidic channel, microfluidic channel, or focusing channel), an interrogation region 200, 200′, and an outlet region 300, 300′. The microfluidic channel structure 10′ in FIG. 1A differs from the microfluidic channel structure 10 in FIG. 1 in the configuration of the sheath fluid structure 100, intersection 102, and sample fluid channel 150, but is otherwise substantially similar. For example, all elements of the microfluidic channel structures 10, 10′ downstream of the intersection 102, 102′ may be identical or may differ only in length or cross-sectional area at any given point.

In operation, a sheath or buffer fluid, which is a fluid suitable for hydrodynamic focusing in a microfluidic environment, is introduced into the sheath fluid channel structure 100 and proceeds through one or more sheath fluid channels 110 to an intersection 102. The intersection 102 may comprise one or more intersections. A sample fluid is introduced into the sample fluid 150 via one or more inlets and flows into the intersection 102. At the intersection 102 the sample fluid is surrounded by the sheath fluid on all sides or on at least three sides and flows in laminar flow with the sheath fluid into the flow channel 104.

In one embodiment the sample fluid channel 104 comprises one or more geometric features, such as expansion regions or a ramp and/or a taper to provide one or both of a reduction in channel size horizontally or vertically, and which are used to position the sample fluid with respect to the intersection 102 and flow channel 104 and to condition the flow characteristics of a sample fluid within the channel, such as to increase its velocity or provide particle spacing.

Further downstream is the interrogation region 200. In one embodiment, the width of the microfluidic channel at the interrogation region 200 is less than that of the flow channel 104. In another embodiment the width and height are both less than those of the flow channel 104, or may be the same depending on the type, nature, and characteristics of the particles and sample fluid being interrogated. The purpose of the interrogation region 200 is to optimally position and condition the flow stream (including the particles, such as sperm cells, suspended or disposed therein), comprising the sample fluid stream and the sheath or buffer fluid stream, for interrogation by an interrogation means. In one embodiment, the interrogation means is an emitter of light and a detector. The emitter of light may be an emitter of electromagnetic radiation, such as a laser, which may be a continuous wave laser or a pulsed laser, or the emitter may be another light source such as a light emitting diode or an arc lamp. The detector may be any suitable detector such as an avalanche photodiode or a photomultiplier tube. The emitter and detector are used to interrogate particles within or suspended in the sample fluid steam, such as dye-stained sperm cells. However, other particle types and other interrogation, tagging, and identification methods are contemplated herein.

The interrogation region 200 may further comprise an action region. The action region may be a portion downstream of an interrogation and detection of a particle wherein a particle is acted upon. The interrogation and action on a particle occurs at the point 292. The interrogation and action on the particle may be separated by as few as 50 microns, or as many as several hundred microns. In one embedment they are separated by one of 50, 100, 150, or 200 microns. For example, a particle may be acted upon by the or another electromagnetic radiation emission source to deactivate, slice, kill, or ablate the particle. In another embodiment, an actuator is used to generate a pulse or jet of fluid to divert a particle from the sample fluid stream into the sheath or buffer fluid stream, or into another waste fluid stream. In another embodiment, a series of light sources or waveguides may be used as optical traps or tweezers to divert a particle from the sample fluid stream. In whichever form the interrogation and action take place within, or after, the interrogation region, the focusing will have properly conditioned, such as by orienting, aligning, and or spacing, such as in a substantially single file line, the particles in the sample fluid for interrogation.

With reference now to FIG. 2, what is provided is a view of an interrogation region 200 of the microfluidic channel structure 10. The flow channel 104 comprises a first or left side 103, a second or right side 105, and narrows via tapering section 108 to the interrogation channel 202. The interrogation channel 202 comprises the interrogation and action location 292. Downstream of the interrogation and action location 292 the channel expands into the outlet region 900.

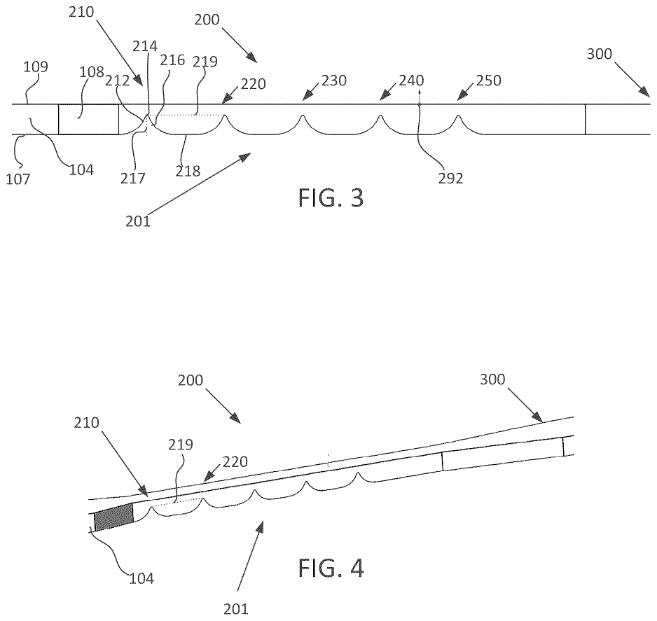

The interrogation region 200 further comprises one or more microweir structures, such as a set of at least one microweir structure, therein. The microweir structures, various non-limiting configurations or embodiments of which are provided and discussed in more detail in at least FIGS. 3-23, function to position and condition a sample fluid stream within the interrogation region to provide optimal conditions at the interrogation and action region 292.

Referring back to FIGS. 1 and 1A, the outlet region 300 comprises an expansion region and first, second, and third outlet channels 310. The outlet channels 310 each comprise an outlet which provides for fluids and/or particles to exit the microfluidic channel structure 10. Downstream of the interrogation region 200, the outlet region 300 provides for a reduction in pressure via a widening of the channel height and/or width at the expansion region. In one embodiment, the sample fluid substantially exits the microfluidic channel structure 10 via the center outlet, and sheath or buffer fluid exits though the top and bottom (left and right) outlets. In another embodiment, only desired particles in the sample fluid exit through the center outlet, while waste components and sheath or buffer fluid exit through the top and bottom (left and right) outlets.

With reference now to FIG. 3, what is provided is a longitudinal cross section view of an interrogation region 200 of a microfluidic channel structure 10 according to one embodiment. Upstream of the interrogation region 200, the flow channel 104, which comprises an upper surface 109 (which may also be referred to as a first surface or a top surface) and lower surface 107 (which may also be referred to as a second surface or a bottom surface) may narrow horizontally such as in the tapering section 108.

In the interrogation region 200, a set of microweir structures 201 are disposed on, or as part of, the lower surface 107. The set of microweir structures 201 comprises a first microweir structure 210, a second microweir structure 220, a third microweir structure 230, a fourth microweir structure 240, and a fifth microweir structure 250.

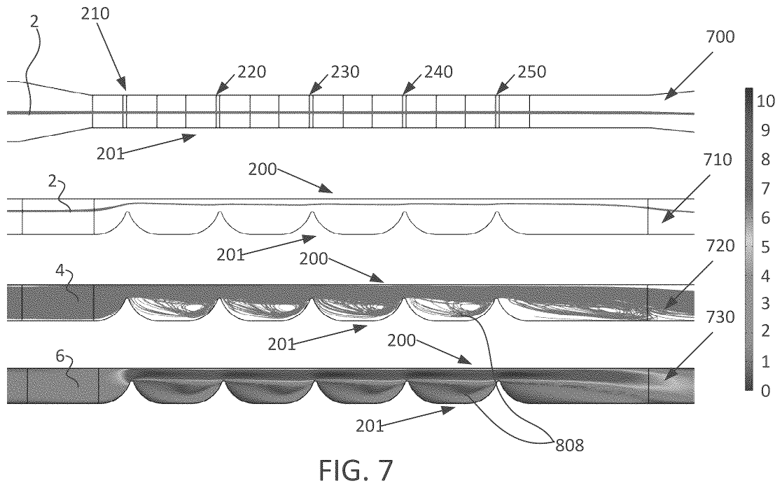

The microweir structure 210 comprises an upstream or first curvilinear surface 212, a highest point or top 214, a downstream or second curvilinear surface 216, and a height 217. A flat portion 218 is disposed between the first microweir structure 210 and the second microweir structure 220, and the distance 219 between the first microweir structure 210 and the second microweir structure 220 may be set to determine a size and effect of a downstream vortex (such as shown in FIG. 7) and the vortex's, and also the microweir structure's, effect on the focusing and positioning of a sample stream.

The number and arrangement of the microweir structures in the set of microweir structures 201 may be changed to provide for desired flow and focusing conditions in the interrogation region. For example, pressure may be lowered by increasing the distance between the upper surface 109 and the highest point 214 of the microweir structure, and the size and effect of a downstream vortex and its contribution to focusing and positioning of a sample stream is determined by the size of the microweir structure and the distance between microweir structures.

In one embodiment, the interrogation and action region 292 comprises an interrogation point and an action point. In another embodiment, the interrogation and action region 292 comprises only an interrogation point and action on any particle in the sample stream occurs downstream of the interrogation and action point 292. The interrogation and action region 292 is depicted as being between microweir 240 and microweir 250, but may instead be positioned between any two microweirs in the set of microweirs 201. For example, the interrogation and action region may be disposed between microweirs 210 and 220, or may be positioned downstream of the last microweir, microweir 250.

With reference now to FIG. 4, a side perspective view of the exterior of an interrogation region 200 of a microfluidic channel structure 10 comprising a set of microweir structures 201 according to one embodiment is provided. As can be seen in FIG. 4, the microweir structures in the set of microweir structures 201 extend to the sides of the microfluidic channel structure. In one embodiment, the microweir structures 201 each extend from first sidewall (e.g., 103) to a second sidewall (e.g., 105). It can also be seen that the each microweir structure extends vertically upward into the flow channel 104, but does not fully block or occlude the channel, thereby permitting a fluid to flow over the microweir structures downstream.

In one embodiment, the width of the flow channel (104) prior to the interrogation region (200) is 250 microns, and the height is 150 microns. In the interrogation region (200), the width narrows from 250 microns upstream of the interrogation region (200) to 135 microns at the interrogation region (200). Each microweir structure in the set of microweir structures (201) has a height (217) of 95.5 microns, with a distance from the top (214) of the microweir structure to the top (109) of the flow channel (104) of 54.5 microns. The distance between microweir structures (219), such as microweir (210) and microweir (220) is 389 microns. In this embodiment, the shape of the upstream portion (212) and downstream portion (216) is defined by a circle having a radius of 0.2069-0.3039 mm, and the shape of the top (214) is defined by a circle having a radius of 0.008 mm. In one embodiment, a curvature of an upstream surface of the curved structure of a microweir is defined by a circle having a diameter of between 206 and 303 microns, a curvature of a downstream surface of the curved structure is defined by a circle having a diameter of between 206 and 303 microns, a top of the curved structure disposed between the upstream surface and the downstream surface is a curved surface defined by a circle having a radius of 8 microns, and a height of the curved structure is between 70 and 110 microns.

The curvilinear shape of a microweir may also be defined as a substantially sinusoidal-shaped structure or as a substantially derivative sigmoid-shaped structure. The shape of a microweir may be a curved structure wherein the shape of the curved structure at a longitudinal cross-section is defined by the formula:

$$y = \frac{1}{\sqrt[σ]{2 π}} {e}^{- \frac{{( x - μ )}^{2}}{2 {σ}^{2}}} ;$$

the shape of the curved structure at a longitudinal cross-section is defined by the formula:

y=e^{-x}^{²};
or the shape of the curved structure at a longitudinal cross-section is defined by the formula:

$$\frac{{e}^{- x}}{{( 1 + {e}^{- x} )}^{2}} .$$

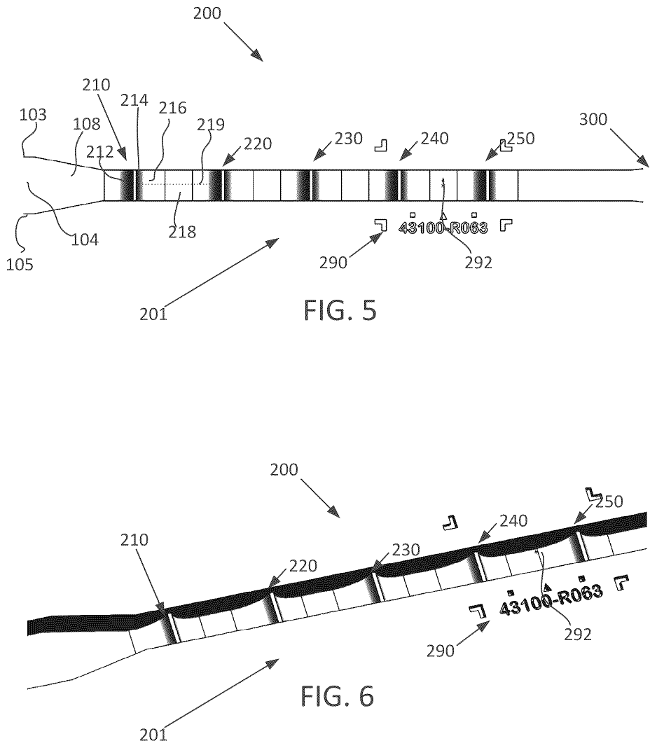

With reference now to FIG. 5, what is provided is a top, detail plan view of an interrogation region 200 depicted as a portion of a substrate layer in which a microfluidic channel structure 10 is disposed according to one embodiment. Upstream of the interrogation region 200, the flow channel 104, which comprises an first side 103 and a second side 105 may narrow horizontally such as in the tapering section 108.

In the interrogation region 200, a set of microweir structures 201 are disposed on, or as part of, the lower surface 107, shown in FIG. 4 as a rendering of a lower substrate layer of a microfluidic chip. The set of microweir structures 201 comprises a first microweir structure 210, a second microweir structure 220, a third microweir structure 230, a fourth microweir structure 240, and a fifth microweir structure 250.

The microweir structure 210 comprises an upstream or first curvilinear surface 212, a highest point or top 214, a downstream or second curvilinear surface 215, and a height 217. A flat portion 218 is disposed between the first microweir structure 210 and the second microweir structure 220, and the distance 219 between the first microweir structure 210 and the second microweir structure 220 may be set to determine a size and effect of a downstream vortex (such as shown in FIG. 7) and the vortex's, and also the microweir structure's, effect on the focusing and positioning of a sample stream.

Adjacent to the set of microweir structures 201 is a fiducial marking 290. The fiducial marking 290 is not part of the microfluidic channel structure, but is instead printed or etched into the substrate in which the microfluidic channel structure is disposed. The fiducial marking 290 comprises a set of geometric fiducial markers, which may be shapes or characters, and further comprises a set of identifying characters to identify the type or version of the microfluidic channel structure. The fiducial marking 290 may be used by an instrument operator or technician to ensure that the microfluidic chip and its microfluidic channel structure is properly oriented and aligned in a flow cytometer instrument, such as a semen sexing instrument comprising a interrogation laser, a detector, and an ablation laser, such that the interrogation, detection, and ablation systems may act on particles in a sample fluid stream. For example, the fiducial marking 290 may be used to properly position and align the interrogation and action region 292 between the microweir structures 240 and 250.

With reference now to FIG. 6, a top perspective view of the exterior of an interrogation region 200 of a microfluidic channel structure 10 comprising a set of microweir structures 201 is provided. As can be seen in FIG. 4, the microweir structures in the set of microweir structures 201 extend to the sides of the microfluidic channel structure. In one embodiment, the microweir structures 201 each extend from first sidewall (e.g., 103) to a second sidewall (e.g., 105). It can also be seen that the each microweir structure extends vertically upward into the flow channel 104, but does not fully block or occlude the channel, thereby permitting a fluid to flow over the microweir structures downstream.

With reference now to FIGS. 7-8, 13-14, 19-20, and 22-23, various views of a flow simulation of a sample fluid 2 and a sheath or buffer fluid in a microfluidic channel structure 10 are provided. The views provided in FIGS. 7-8, 13-14, 19-20, and 22-23 represent the real-world flow of a sample fluid 2 in a laminar flow regime with a sheath or buffer fluid in the microfluidic channel structure 10 through a software simulation, such as in a COMSOL® MULTIPHYSICS® software simulation program.

With reference now to FIG. 7, various simulation views 700, 710, 720, and 730 of the interrogation region 200 are provided. In the simulation views in FIG. 7, a sample fluid 2 is flowed into a sample fluid inlet upstream of the interrogation region 200 and the sample fluid 2 stream flows relatively downstream toward the intersection. At the intersection the sample fluid is surrounded by a sheath or buffer fluid and the fluids flow in laminar flow towards the interrogation region 200. At the interrogation region 200, the sample fluid 2 is focused or further focused by the set of microweir structures 201 including microweir structures 210, 220, 230, 240, and 250. As the sample fluid 2 flows over the set of microweir structures 201 in succession, the sample fluid 2 is focused and is held or maintained at a position relatively near the top surface of the flow channel. Being in proximity to the top surface of the flow channel imparts shear forces on particles (such as cells, e.g., sperm cells) suspended in the sample fluid 2. These forces cause the particles within the sample fluid 2 to become oriented within the sample fluid 2 as the particles flow downstream through the interrogation region 200. At any midpoint between any two microweir structures, the particles within the sample fluid 2 may be interrogated and acted upon, such as to ablate or sort the particles. As can be seen in the top view 700 and the side view 710, the sample fluid 2 is maintained as a thin streamline proximate to the top surface within the microfluidic flow channel.

As seen in simulation views 700 and 710, when the sample fluid 2, which is a focused fluid stream, flows through the interrogation region 200, the focused stream 2 is optimally shaped and conditioned such that any particles suspended or disposed within the focused stream 2 may be interrogated or identified. For example, the stream 2 may be positioned to be in the optimal location to be within the focal plane of a laser and may have a width and particle velocity variation that are small enough to permit individual interrogation of particles within the focused stream 2. In one embodiment, the stream position is offset 10-30 microns from either the centerline or top surface, the stream position horizontally is within 50 microns of the centerline, the stream width is 2-100 microns, and the particle velocity is approximately 5-15 m/s at a sheath or buffer fluid flow rate of 2-4 mL/min.

Simulation view 730 depicts a fluid flow 4, which comprises both the sample fluid 2 and a sheath or buffer fluid, flowing through the interrogation region. Downstream of each of the microweirs in the set of microweirs 201 a rotating vortex 808 of lower pressure and fluid velocity is formed. The vortex 808 is a lower velocity region that rotates downstream of a microweir. The effect of the vortex 808, which is entirely composed of the sheath or buffer fluid, is to form an area of higher velocity in the portion of the flow channel above the microweir structures 201. This causes a focusing effect on the sample fluid 2, which maintains a tight, focused stream throughout the interrogation region 200. As shown in simulation view 730, the area of higher velocity (darker region at the top of the channel) is maintained above the microweir structures 201 and the vortexes (area of lower velocity and lighter region at the bottom of the channel between the microweir structures) are maintained between the microweir structures. A region, or barrier, of a medium, moderate, or in-between velocity separates the higher velocity fluid flows at the top of the channel from the vortex at the bottom.

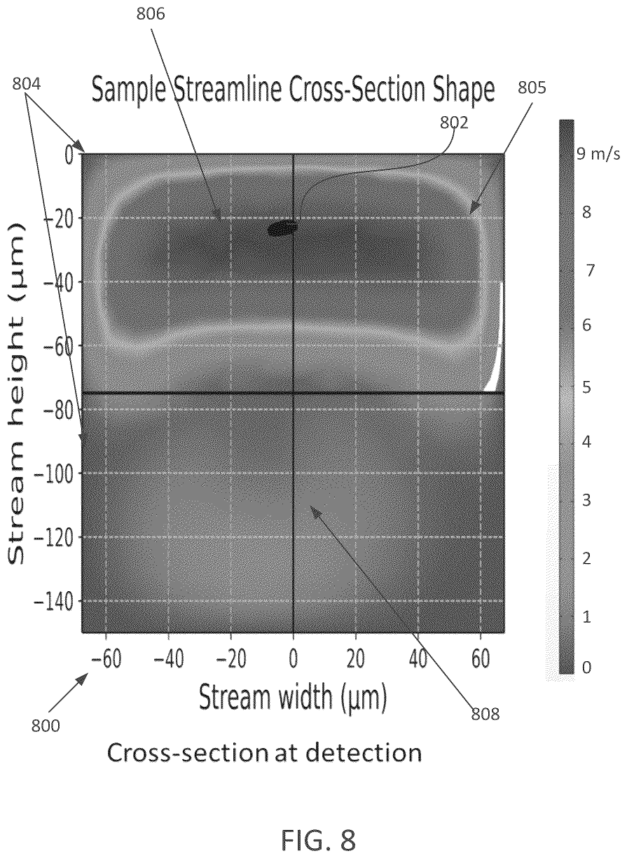

With reference now to FIG. 8, the velocity profile for fluid flows within the microfluidic channel structure 10 and the simulated position of particles 802 within the fluid flow at the interrogation region 200 is provided. The graphs of the velocity profile 800 shown in FIG. 8 represents the flow conditions at the interrogation and action region in the interrogation region 200, such as shown between microweirs 240 and 250 in FIG. 7.

In the velocity magnitude graph 800, it can be seen that the magnitude of velocity of the fluid flow within the channel increases inwardly towards the center of the channel with the velocity being near 0 m/s at the edges and greater than 9 m/s towards the center of the channel. It can also be appreciated that there is a gradient of velocity that increases towards the center of the channel. The relative size and position of a sample stream 802 is provided. The location of the stream is offset by 15-30 microns from a top surface, and approximately 0-5 microns from the centerline horizontally. The size of the stream is approximately 5-20 microns in width and height. The graph 800 overlays the stream position shown in the graph with the velocity gradient shown. Areas of lower velocity 804 (0-2 m/s) are shown near the edges of the rectangular channel, and an area of a medium velocity 805 (approximately 5 m/s) separates the areas of lower velocity 804 from the region of higher velocity 806. The region wherein the vortex 808 is disposed can be seen below the areas of medium 805 and higher 805 velocity and is surrounded by a region of lower velocity 804. The effect of the relatively lower velocity regions 804 and the vortex 808 is to confine the area of higher velocity 806 to the upper portion of the channel. This confines the sample fluid 802 in the area of higher velocity 806, causing the sample fluid to become and stay focused as it flows through the interrogation region 200.

A non-uniform velocity profile for the sample fluid stream would lead to particles within the stream having varying, or non-uniform, velocities. For example, if attempting to interrogate particles at a first location and acting on particles at a second location downstream of the first location, the velocity of the particles may vary by +/−2 m/s and the position of the particles at the second location may vary by 1-15 microns, depending on how far downstream the second location is from the first location. Minimizing the velocity variation is important to accurate measurement and action on the particles. Therefore, it is desirable to obtain a more uniform velocity profile for the sample stream and particles therein. This can be achieved at least in part by one or more of the design, position, configuration, and/or geometry of one or more microweir structures at or in the interrogation region.

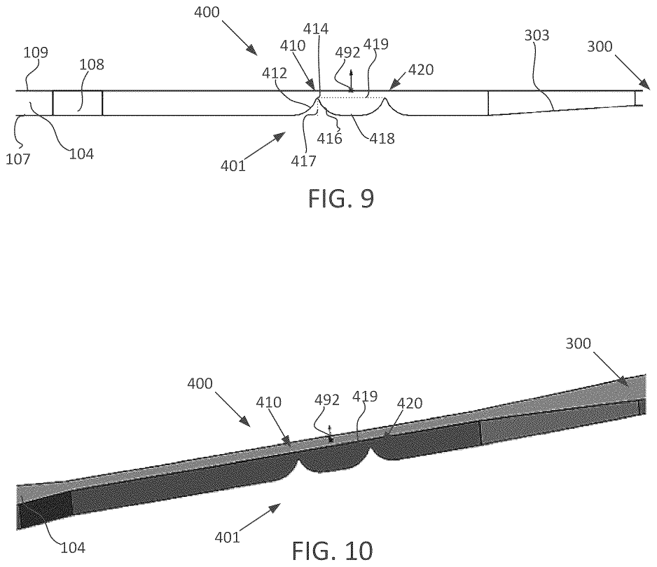

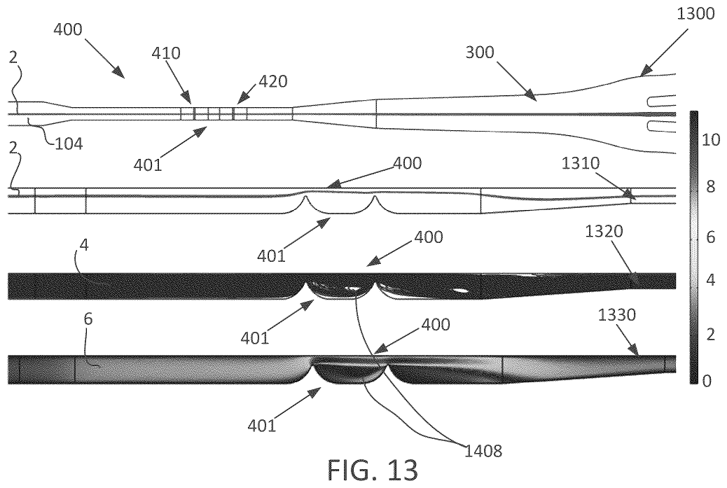

With reference now to FIGS. 9-12, 16-18, and 21-22, what are provided are alternate embodiments of microfluidic channel structures comprising at least one curvilinear microweir structure, and associated velocity gradient graphs in FIGS. 13-14, 19-20, and 22-23. The microfluidic channel structures shown in FIGS. 9-12, 16-18, and 21-22, achieve the same function as the set of microweirs 201 shown in FIGS. 3-6, however, variations in flow channel length, flow channel cross-sectional area, number and type of microweir structures, and cross-sectional area of the interrogation region are used to set the position and flow characteristics of the sample fluid stream and the velocity, position, and orientation of particles therein.

For example, in one embodiment as shown in the microfluidic channel structure in FIG. 9, what is provided is a longitudinal cross section view of an interrogation region 400 of a microfluidic channel structure 10 according to one embodiment. Upstream of the interrogation region 400, the flow channel 104, which comprises an upper surface 109 and lower surface 107 may narrow horizontally such as in the tapering section 108.

In the interrogation region 400, a set of microweir structures 401 are disposed on, or as part of, the lower surface 107. The set of microweir structures 401 comprises a first microweir structure 410 and a second microweir structure 420. As can be appreciated, the set of microweir structures 401 achieves similar, if not nearly identical, focusing and orientation functionality to the set of microweir structures 201. It was unexpectedly discovered that for discriminating between particles at an interrogation or action region 492 (similar to the interrogation or action region 292 in FIGS. 3-6), a set of two microweir structures 401 positioned within the interrogation region 400 performed similarly to the set of microweir structures 201 while reducing the overall fluid pressure in the microfluidic channel structure.

The microweir structure 410 comprises an upstream or first curvilinear surface 412, a highest point or top 414, a downstream or second curvilinear surface 415, and a height 417. A flat portion 418 is disposed between the first microweir structure 410 and the second microweir structure 420, and the distance 419 between the first microweir structure 410 and the second microweir structure 420 may be set to determine a size and effect of a downstream vortex (such as shown in FIG. 13) and the vortex's, and also the microweir structure's, effect on the focusing and positioning of a sample stream.

In one embodiment, the interrogation and action region 492 comprises an interrogation point and an action point. In another embodiment, the interrogation and action region 492 comprises only an interrogation point and action on any particle in the sample stream occurs downstream of the interrogation and action point 492.

With reference now to FIG. 10, a side perspective view of the exterior of an interrogation region 400 of a microfluidic channel structure comprising a set of microweir structures 401 according to one embodiment is provided. As can be seen in FIG. 10, the microweir structures in the set of microweir structures 401 extend to the sides of the microfluidic channel structure. In one embodiment, the microweir structures 401 each extend from first sidewall (e.g., 103) to a second sidewall (e.g., 105). It can also be seen that the each microweir structure extends vertically upward into the flow channel 104, but does not fully block or occlude the channel, thereby permitting a fluid to flow over the microweir structures downstream.

In one embodiment, the width of the flow channel (104) prior to the interrogation region (400) is 250 microns, and the height is 150 microns. In the interrogation region (400), the width narrows from 250 microns upstream of the interrogation region (400) to 135 microns at the interrogation region (400). Each microweir structure in the set of microweir structures (401) has a height (417) of 103 microns, with a distance from the top (414) of the microweir structure to the top (109) of the flow channel (104) of 47 microns. The distance between microweir structures (419), such as microweir (410) and microweir (420) is 407 microns, with a flat bottom portion of 120 microns. In this embodiment, the shape of the upstream portion (412) and downstream portion (416) is defined by a circle having a radius of 0.2069-0.3039 mm, and the shape of the top (414) is defined by a circle having a radius of 0.008 mm. Downstream of the interrogation region 400, at the outlet region 300, a ramp 303 decreases the height of the flow channel from 150 microns in the interrogation region 400 to 90 microns at the beginning of the outlet region 300.

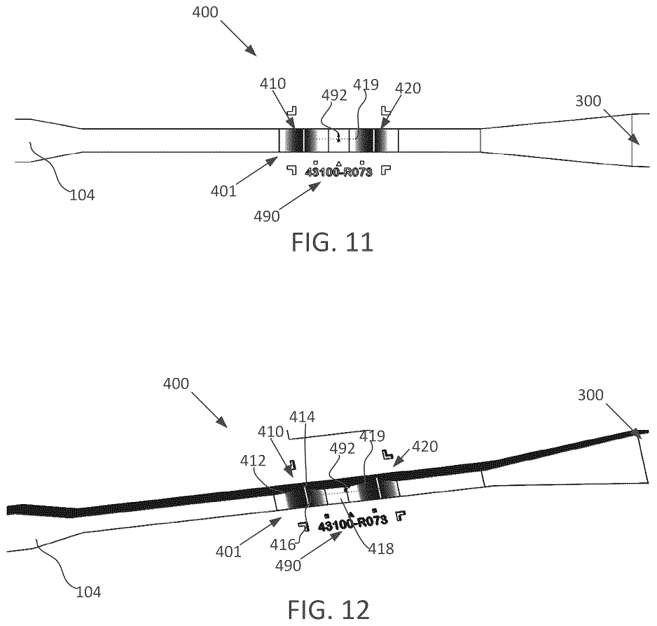

With reference now to FIG. 11, what is provided is a top, detail plan view of an interrogation region 400 depicted as a portion of a substrate layer in which a microfluidic channel structure 10 is disposed according to one embodiment. Upstream of the interrogation region 400, the flow channel 104, which comprises an first side 103 and a second side 105 may narrow horizontally such as in the tapering section 108.

In the interrogation region 400, a set of microweir structures 401 are disposed on, or as part of, the lower surface 107, shown in FIG. 11 as a rendering of a lower substrate layer of a microfluidic chip. The set of microweir structures 401 comprises a first microweir structure 410 and a second microweir structure 420.

The microweir structure 410 comprises an upstream or first curvilinear surface 412, a highest point or top 414, a downstream or second curvilinear surface 415, and a height 417. A flat portion 418 is disposed between the first microweir structure 410 and the second microweir structure 420, and the distance 419 between the first microweir structure 410 and the second microweir structure 420 may be set to determine a size and effect of a downstream vortex (such as shown in FIG. 13) and the vortex's, and also the microweir structure's, effect on the focusing and positioning of a sample stream.

With reference now to FIG. 12, a top perspective view of the exterior of an interrogation region 400 of a microfluidic channel structure 10 comprising a set of microweir structures 401 is provided. As can be seen in FIG. 12, the microweir structures in the set of microweir structures 401 extend to the sides of the microfluidic channel structure. In one embodiment, the microweir structures 401 each extend from first sidewall (e.g., 103) to a second sidewall (e.g., 105). It can also be seen that the each microweir structure extends vertically upward into the flow channel 104, but does not fully block or occlude the channel, thereby permitting a fluid to flow over the microweir structures downstream.

Adjacent to the set of microweir structures 401 is a fiducial marking 490. The fiducial marking 490 is not part of the microfluidic channel structure, but is instead printed or etched into the substrate in which the microfluidic channel structure is disposed. The fiducial marking 490 comprises a set of geometric fiducial markers, which may be shapes or characters, and further comprises a set of identifying characters to identify the type or version of the microfluidic channel structure.

With reference now to FIG. 13, various simulation views 1300, 1310, 1320, and 1330 of the interrogation region 200 are provided. In the simulation views in FIG. 13, a sample fluid 2 is flowed into a sample fluid inlet upstream of the interrogation region 400 and the sample fluid 2 stream flows relatively downstream toward the intersection. At the intersection the sample fluid is surrounded by a sheath or buffer fluid and the fluids flow in laminar flow towards the interrogation region 400. At the interrogation region 400, the sample fluid 2 is focused or further focused by the set of microweir structures 401 including microweir structures 410 and 420. As the sample fluid 2 flows over the set of microweir structures 401 in succession, the sample fluid 2 is focused and is held or maintained at a position relatively near the top surface of the flow channel. Being in proximity to the top surface of the flow channel imparts shear forces on particles (such as cells, e.g., sperm cells) suspended in the sample fluid 2. These forces cause the particles within the sample fluid 2 to become oriented within the sample fluid 2 as the particles flow downstream through the interrogation region 400. At the midpoint between the two microweir structures, the particles within the sample fluid 2 may be interrogated and acted upon, such as to ablate or sort the particles. As can be seen in the top view 1300 and the side view 1310, the sample fluid 2 is maintained as a thin streamline proximate to the top surface within the microfluidic flow channel.

As seen in simulation views 1300 and 1310, when the sample fluid 2, which is a focused fluid stream, flows through the interrogation region 400, the focused stream 2 is optimally shaped and conditioned such that any particles suspended or disposed within the focused stream 2 may be interrogated or identified. For example, the stream 2 may be positioned to be in the optimal location to be within the focal plane of a laser and may have a width and particle velocity variation that are small enough to permit individual interrogation of particles within the focused stream 2.

Simulation view 1330 depicts a fluid flow 4, which comprises both the sample fluid 2 and a sheath or buffer fluid, flowing through the interrogation region. Downstream of each of the microweirs in the set of microweirs 401 a rotating vortex 1408 of lower pressure and fluid velocity is formed. The vortex 1408 is a lower velocity region that rotates downstream of a microweir. The effect of the vortex 1408, which is entirely composed of the sheath or buffer fluid, is to form an area of higher velocity in the portion of the flow channel above the microweir structures 401. This causes a focusing effect on the sample fluid 2, which maintains a tight, focused stream throughout the interrogation region 400. As shown in simulation view 1340, the area of higher velocity (darker region at the top of the channel) is maintained above the microweir structures 401 and the vortexes (area of lower velocity and lighter region at the bottom of the channel between the microweir structures) are maintained between the microweir structures. A region, or barrier, of a medium, moderate, or in-between velocity separates the higher velocity fluid flows at the top of the channel from the vortex at the bottom.

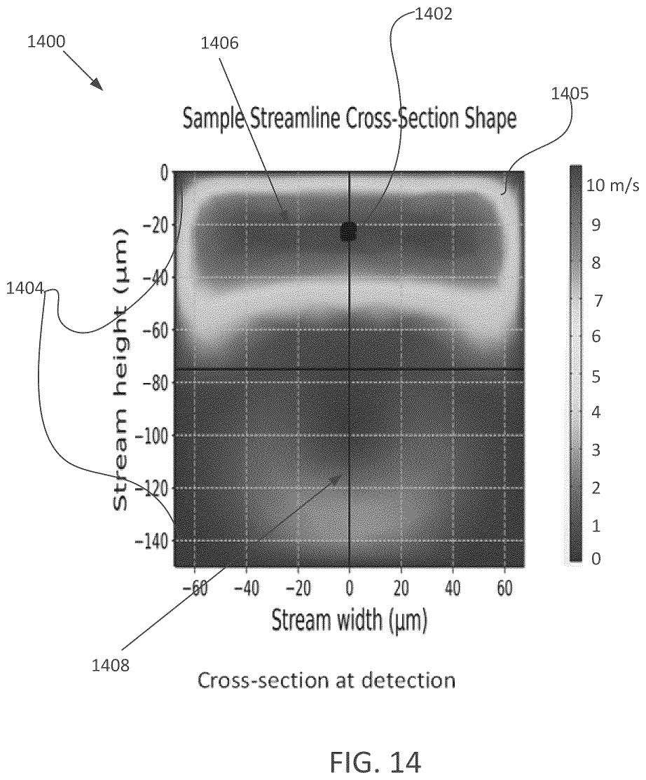

With reference now to FIG. 14, the velocity profile for fluid flows within the microfluidic channel structure 10 and the simulated position of particles 1402 within the fluid flow at the interrogation region 400 is provided. The graphs of the velocity profile 1400 shown in FIG. 14 represents the flow conditions at the interrogation and action region in the interrogation region 400, such as shown between microweirs 410 and 420 in FIG. 13.

In the velocity magnitude graph 1400, it can be seen that the magnitude of velocity of the fluid flow within the channel increases inwardly towards the center of the channel with the velocity being near 0 m/s at the edges and greater than 9 m/s towards the center of the channel. It can also be appreciated that there is a gradient of velocity that increases towards the center of the channel. The relative size and position of a sample stream 1402 is provided. The location of the stream is offset by 15-30 microns from a top surface, and approximately 0-5 microns from the centerline horizontally. The size of the stream is approximately 5-20 microns in width and height. The graph 1400 overlays the stream position shown in the graph with the velocity gradient shown. Areas of lower velocity 1404 (0-2 m/s) are shown near the edges of the rectangular channel, and an area of a medium velocity 1405 (approximately 5 m/s) separates the areas of lower velocity 1404 from the region of higher velocity 1406. The region wherein the vortex 1408 is disposed can be seen below the areas of medium 1405 and higher 1405 velocity and is surrounded by a region of lower velocity 1404. The effect of the relatively lower velocity regions 1404 and the vortex 1408 is to confine the area of higher velocity 1406 to the upper portion of the channel. This confines the sample fluid 1402 in the area of higher velocity 1406, causing the sample fluid to become and stay focused as it flows through the interrogation region 400.

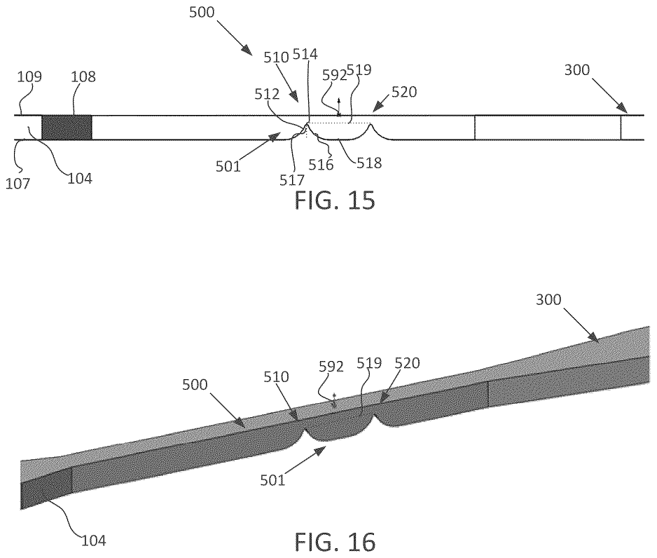

In another embodiment as shown in the microfluidic channel structure in FIG. 15, what is provided is a longitudinal cross section view of an interrogation region 500 of a microfluidic channel structure 10 according to one embodiment. Upstream of the interrogation region 500, the flow channel 104, which comprises an upper surface 109 and lower surface 107 may narrow horizontally such as in the tapering section 108.

In the interrogation region 500, a set of microweir structures 501 are disposed on, or as part of, the lower surface 107. The set of microweir structures 501 comprises a first microweir structure 510 and a second microweir structure 520.

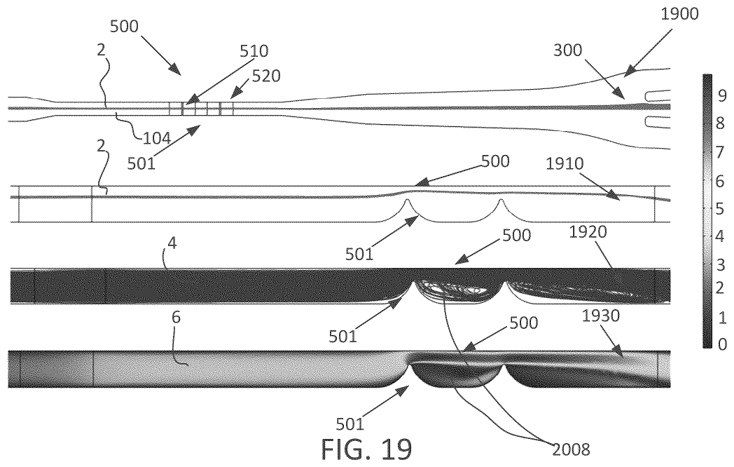

The microweir structure 510 comprises an upstream or first curvilinear surface 512, a highest point or top 514, a downstream or second curvilinear surface 515, and a height 517. A flat portion 518 is disposed between the first microweir structure 510 and the second microweir structure 520, and the distance 519 between the first microweir structure 510 and the second microweir structure 520 may be set to determine a size and effect of a downstream vortex (such as shown in FIG. 19) and the vortex's, and also the microweir structure's, effect on the focusing and positioning of a sample stream.

In one embodiment, the interrogation and action region 592 comprises an interrogation point and an action point. In another embodiment, the interrogation and action region 592 comprises only an interrogation point and action on any particle in the sample stream occurs downstream of the interrogation and action point 592.

With reference now to FIG. 16, a side perspective view of the exterior of an interrogation region 500 of a microfluidic channel structure comprising a set of microweir structures 501 according to one embodiment is provided. As can be seen in FIG. 16, the microweir structures in the set of microweir structures 501 extend to the sides of the microfluidic channel structure. In one embodiment, the microweir structures 501 each extend from first sidewall (e.g., 103) to a second sidewall (e.g., 105). It can also be seen that the each microweir structure extends vertically upward into the flow channel 104, but does not fully block or occlude the channel, thereby permitting a fluid to flow over the microweir structures downstream.

In one embodiment, the width of the flow channel (104) prior to the interrogation region (500) is 250 microns, and the height is 150 microns. In the interrogation region (500), the width narrows from 250 microns upstream of the interrogation region (500) to 135 microns at the interrogation region (500). Each microweir structure in the set of microweir structures (501) has a height (517) of 95.5 microns, with a distance from the top (514) of the microweir structure to the top (109) of the flow channel (104) of 54.5 microns. The distance between microweir structures (519), such as microweir (510) and microweir (520) is 389 microns, with a flat bottom portion of 120 microns. In this embodiment, the shape of the upstream portion (512) and downstream portion (516) is defined by a circle having a radius of 0.2069-0.3039 mm, and the shape of the top (514) is defined by a circle having a radius of 0.008 mm.

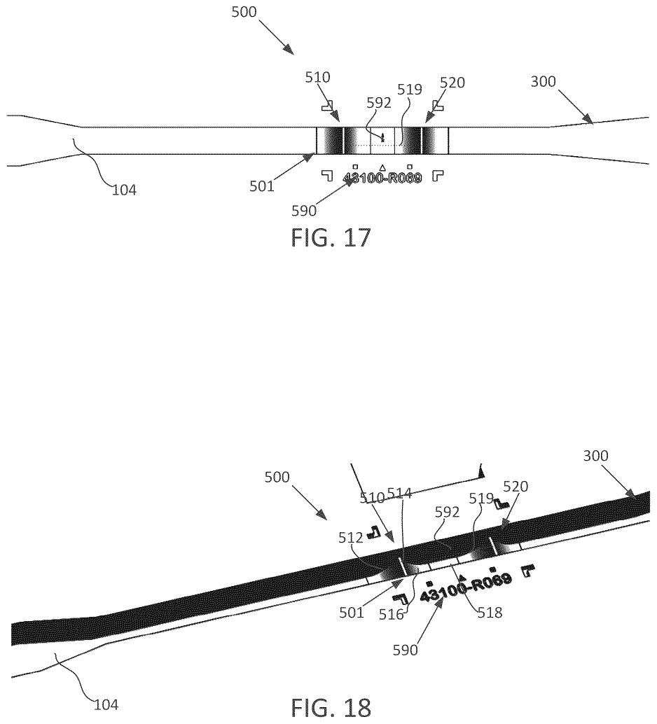

With reference now to FIG. 17, what is provided is a top, detail plan view of an interrogation region 500 depicted as a portion of a substrate layer in which a microfluidic channel structure 10 is disposed according to one embodiment. Upstream of the interrogation region 500, the flow channel 104, which comprises an first side 103 and a second side 105 may narrow horizontally such as in the tapering section 108.

In the interrogation region 500, a set of microweir structures 501 are disposed on, or as part of, the lower surface 107, shown in FIG. 17 as a rendering of a lower substrate layer of a microfluidic chip. The set of microweir structures 501 comprises a first microweir structure 510 and a second microweir structure 520.

The microweir structure 510 comprises an upstream or first curvilinear surface 512, a highest point or top 514, a downstream or second curvilinear surface 515, and a height 517. A flat portion 518 is disposed between the first microweir structure 510 and the second microweir structure 520, and the distance 519 between the first microweir structure 510 and the second microweir structure 520 may be set to determine a size and effect of a downstream vortex (such as shown in FIG. 19) and the vortex's, and also the microweir structure's, effect on the focusing and positioning of a sample stream.

Adjacent to the set of microweir structures 501 is a fiducial marking 590. The fiducial marking 590 is not part of the microfluidic channel structure, but is instead printed or etched into the substrate in which the microfluidic channel structure is disposed. The fiducial marking 590 comprises a set of geometric fiducial markers, which may be shapes or characters, and further comprises a set of identifying characters to identify the type or version of the microfluidic channel structure.

With reference now to FIG. 18, a top perspective view of the exterior of an interrogation region 500 of a microfluidic channel structure 10 comprising a set of microweir structures 501 is provided. As can be seen in FIG. 18, the microweir structures in the set of microweir structures 501 extend to the sides of the microfluidic channel structure. In one embodiment, the microweir structures 501 each extend from first sidewall (e.g., 103) to a second sidewall (e.g., 105). It can also be seen that the each microweir structure extends vertically upward into the flow channel 104, but does not fully block or occlude the channel, thereby permitting a fluid to flow over the microweir structures downstream.

With reference now to FIG. 19, various simulation views 1900, 1910, 1920, and 1930 of the interrogation region 500 are provided. In the simulation views in FIG. 19, a sample fluid 2 is flowed into a sample fluid inlet upstream of the interrogation region 500 and the sample fluid 2 stream flows relatively downstream toward the intersection. At the intersection the sample fluid is surrounded by a sheath or buffer fluid and the fluids flow in laminar flow towards the interrogation region 500. At the interrogation region 500, the sample fluid 2 is focused or further focused by the set of microweir structures 501 including microweir structures 510 and 520. As the sample fluid 2 flows over the set of microweir structures 501 in succession, the sample fluid 2 is focused and is held or maintained at a position relatively near the top surface of the flow channel. Being in proximity to the top surface of the flow channel imparts shear forces on particles (such as cells, e.g., sperm cells) suspended in the sample fluid 2. These forces cause the particles within the sample fluid 2 to become oriented within the sample fluid 2 as the particles flow downstream through the interrogation region 500. At the midpoint between the two microweir structures, the particles within the sample fluid 2 may be interrogated and acted upon, such as to ablate or sort the particles. As can be seen in the top view 1900 and the side view 1910, the sample fluid 2 is maintained as a thin streamline proximate to the top surface within the microfluidic flow channel.

As seen in simulation views 1900 and 1910, when the sample fluid 2, which is a focused fluid stream, flows through the interrogation region 500, the focused stream 2 is optimally shaped and conditioned such that any particles suspended or disposed within the focused stream 2 may be interrogated or identified. For example, the stream 2 may be positioned to be in the optimal location to be within the focal plane of a laser and may have a width and particle velocity variation that are small enough to permit individual interrogation of particles within the focused stream 2.

Simulation view 1930 depicts a fluid flow 4, which comprises both the sample fluid 2 and a sheath or buffer fluid, flowing through the interrogation region. Downstream of each of the microweirs in the set of microweirs 501 a rotating vortex 2008 of lower pressure and fluid velocity is formed. The vortex 2008 is a lower velocity region that rotates downstream of a microweir. The effect of the vortex 2008, which is entirely composed of the sheath or buffer fluid, is to form an area of higher velocity in the portion of the flow channel above the microweir structures 501. This causes a focusing effect on the sample fluid 2, which maintains a tight, focused stream throughout the interrogation region 500. As shown in simulation view 1940, the area of higher velocity (darker region at the top of the channel) is maintained above the microweir structures 501 and the vortexes (area of lower velocity and lighter region at the bottom of the channel between the microweir structures) are maintained between the microweir structures. A region, or barrier, of a medium, moderate, or in-between velocity separates the higher velocity fluid flows at the top of the channel from the vortex at the bottom.

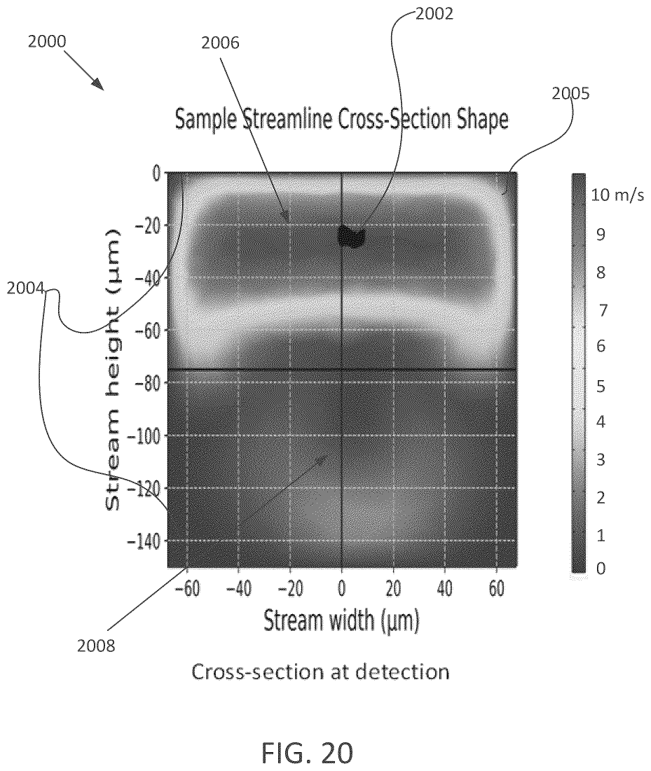

With reference now to FIG. 20, the velocity profile for fluid flows within the microfluidic channel structure 10 and the simulated position of particles 2002 within the fluid flow at the interrogation region 500 is provided. The graphs of the velocity profile 2000 shown in FIG. 20 represents the flow conditions at the interrogation and action region in the interrogation region 500, such as shown between microweirs 510 and 520 in FIG. 19.

In the velocity magnitude graph 2000, it can be seen that the magnitude of velocity of the fluid flow within the channel increases inwardly towards the center of the channel with the velocity being near 0 m/s at the edges and greater than 9 m/s towards the center of the channel. It can also be appreciated that there is a gradient of velocity that increases towards the center of the channel. The relative size and position of a sample stream 2002 is provided. The location of the stream is offset by 15-30 microns from a top surface, and approximately 0-5 microns from the centerline horizontally. The size of the stream is approximately 5-20 microns in width and height. The graph 2000 overlays the stream position shown in the graph with the velocity gradient shown. Areas of lower velocity 2004 (0-2 m/s) are shown near the edges of the rectangular channel, and an area of a medium velocity 2005 (approximately 5 m/s) separates the areas of lower velocity 2004 from the region of higher velocity 2006. The region wherein the vortex 2008 is disposed can be seen below the areas of medium 2005 and higher 2005 velocity and is surrounded by a region of lower velocity 2004. The effect of the relatively lower velocity regions 2004 and the vortex 2008 is to confine the area of higher velocity 2006 to the upper portion of the channel. This confines the sample fluid 2002 in the area of higher velocity 2006, causing the sample fluid to become and stay focused as it flows through the interrogation region 500.

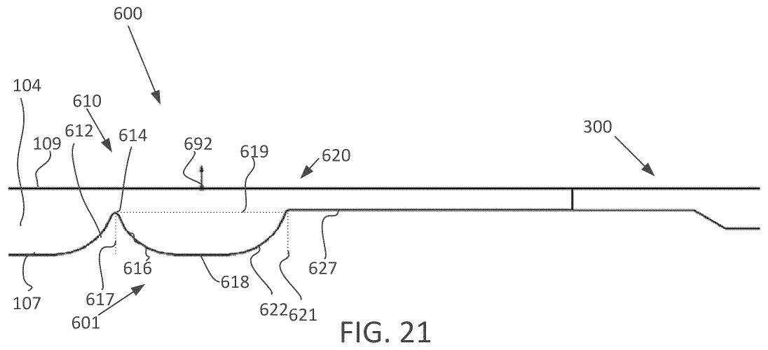

In another embodiment as shown in the microfluidic channel structure in FIG. 21, what is provided is a longitudinal cross section view of an interrogation region 600 of a microfluidic channel structure 10 according to one embodiment. Upstream of the interrogation region 600, the flow channel 104 comprises an upper surface 109 and lower surface 107.

In the interrogation region 600, a set of microweir structures 601 are disposed on, or as part of, the lower surface 107. The set of microweir structures 601 comprises a first microweir structure 510 and a second microweir structure 620.

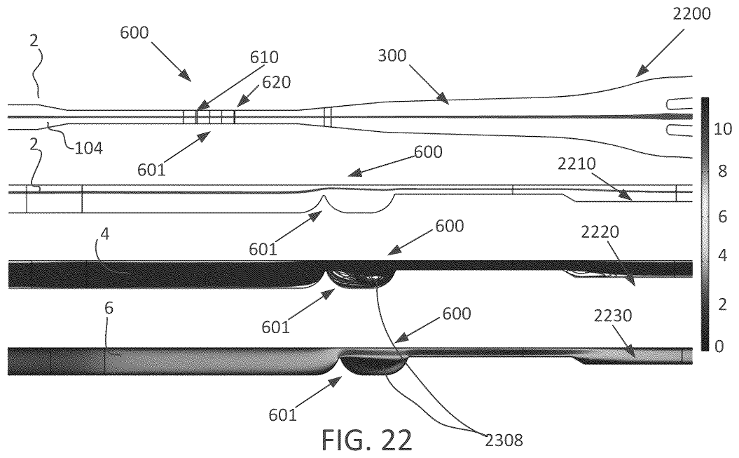

The microweir structure 610 comprises an upstream or first curvilinear surface 612, a highest point or top 614, a downstream or second curvilinear surface 615, and a height 617. A flat portion 618 is disposed between the first microweir structure 610 and the second microweir structure 620, and the distance 619 between the first microweir structure 610 and the second microweir structure 620 may be set to determine a size and effect of a downstream vortex (such as shown in FIG. 22) and the vortex's, and also the microweir structure's, effect on the focusing and positioning of a sample stream.

The microweir structure 620 comprises an upstream portion 622 which is similar to the upstream portion 612 of the microweir 610. However, instead of having a curved downstream portion like the microweir 610, the microweir 620 comprises a flat downstream surface 627. The geometric shape of the microweir 620 provides for a vortex to form upstream of the microweir 620 (like between any of the microweirs in the sets of microweirs 201, 401, and 501), but shifts the bottom surface 627 upwards after or downstream of the interrogation region 600. In this configuration, the downstream shift in the bottom surface (i.e., from the position of the surface 107 to the position of the surface 627) is entirely downstream of and does not overlap with the interrogation region 600. Additionally, the height 621 of the microweir 620 may be greater than the height of the microweir 610. In operation, at the interrogation and action region 692 the conditions of a sample stream (i.e., position, size, velocity, pressure, and focusing characteristics) are substantially similar to any of the interrogation and action regions 292, 492, and 592.

In one embodiment, the interrogation and action region 692 comprises an interrogation point and an action point. In another embodiment, the interrogation and action region 692 comprises only an interrogation point and action on any particle in the sample stream occurs downstream of the interrogation and action point 692.

The microweir structures in the set of microweir structures 601 extend to the sides of the microfluidic channel structure. In one embodiment, the microweir structures 601 each extend from first sidewall (e.g., 103) to a second sidewall (e.g., 105). Additionally, each microweir structure extends vertically upward into the flow channel 104, but does not fully block or occlude the channel, thereby permitting a fluid to flow over the microweir structures downstream.

In one embodiment, the width of the flow channel (104) prior to the interrogation region (600) is 250 microns, and the height is 150 microns. In the interrogation region (600), the width narrows from 250 microns upstream of the interrogation region (600) to 135 microns at the interrogation region (600). The first microweir structure (610) has a height (617) of 95.5 microns, with a distance from the top (614) of the microweir structure to the top (109) of the flow channel (104) of 54.5 microns. The height (621) of the second microweir (620) may be the same as or differ from the height of the first microweir (610), and may be 70-110 microns, with a distance from the top of the microweir (620) to the top (109) of the flow channel (104) of 40-90 microns. The distance between microweir structures (619), such as microweir (610) and microweir (620) is 389 microns, with a flat bottom portion (618) of 120 microns. In this embodiment, the shape of the upstream portion (612) and downstream portion (616) is defined by a circle having a radius of 0.2069-0.3039 mm, and the shape of the top (614) is defined by a circle having a radius of 0.008 mm. The shape of the upstream portion (621) of microweir (620) is defined by a circle having a radius of 0.2069-0.3039 mm.

The flat portion 618 is disposed between the first microweir structure 610 and the second microweir structure 620, and the distance 619 between the first microweir structure 610 and the second microweir structure 620 may be set to determine a size and effect of a downstream vortex (such as shown in FIG. 22) and the vortex's, and also the microweir structure's, effect on the focusing and positioning of a sample stream.

The microweir structures in the set of microweir structures 601 extend to the sides of the microfluidic channel structure. In one embodiment, the microweir structures 601 each extend from first sidewall (e.g., 103) to a second sidewall (e.g., 105). Additionally, each microweir structure extends vertically upward into the flow channel 104, but does not fully block or occlude the channel, thereby permitting a fluid to flow over the microweir structures downstream.

The set of microweir structures 601 may also have a fiducial marking disposed on the substrate adjacent to the structures such as shown and as described above.

With reference now to FIG. 22, various simulation views 2200, 2210, 2220, and 2230 of the interrogation region 600 are provided. In the simulation views in FIG. 22, a sample fluid 2 is flowed into a sample fluid inlet upstream of the interrogation region 600 and the sample fluid 2 stream flows relatively downstream toward the intersection. At the intersection the sample fluid is surrounded by a sheath or buffer fluid and the fluids flow in laminar flow towards the interrogation region 600. At the interrogation region 600, the sample fluid 2 is focused or further focused by the set of microweir structures 601 including microweir structures 610 and 620. As the sample fluid 2 flows over the set of microweir structures 601 in succession, the sample fluid 2 is focused and is held or maintained at a position relatively near the top surface of the flow channel. Being in proximity to the top surface of the flow channel imparts shear forces on particles (such as cells, e.g., sperm cells) suspended in the sample fluid 2. These forces cause the particles within the sample fluid 2 to become oriented within the sample fluid 2 as the particles flow downstream through the interrogation region 600. At the midpoint between the two microweir structures, the particles within the sample fluid 2 may be interrogated and acted upon, such as to ablate or sort the particles. As can be seen in the top view 2200 and the side view 2210, the sample fluid 2 is maintained as a thin streamline proximate to the top surface within the microfluidic flow channel.

As seen in simulation views 2200 and 2210, when the sample fluid 2, which is a focused fluid stream, flows through the interrogation region 600, the focused stream 2 is optimally shaped and conditioned such that any particles suspended or disposed within the focused stream 2 may be interrogated or identified. For example, the stream 2 may be positioned to be in the optimal location to be within the focal plane of a laser and may have a width and particle velocity variation that are small enough to permit individual interrogation of particles within the focused stream 2.

Simulation view 2230 depicts a fluid flow 4, which comprises both the sample fluid 2 and a sheath or buffer fluid, flowing through the interrogation region. Downstream of the first microweir 610 in the set of microweirs 601 a rotating vortex 2308 of lower pressure and fluid velocity is formed. The vortex 2308 is a lower velocity region that rotates downstream of a microweir. The effect of the vortex 2308, which is entirely composed of the sheath or buffer fluid, is to form an area of higher velocity in the portion of the flow channel above the microweir structures 601. This causes a focusing effect on the sample fluid 2, which maintains a tight, focused stream throughout the interrogation region 600. As shown in simulation view 2240, the area of higher velocity (darker region at the top of the channel) is maintained above the microweir structures 601 and the vortex (area of lower velocity and lighter region at the bottom of the channel between the microweir structures) is maintained between the microweir structures. A region, or barrier, of a medium, moderate, or in-between velocity separates the higher velocity fluid flows at the top of the channel from the vortex at the bottom.

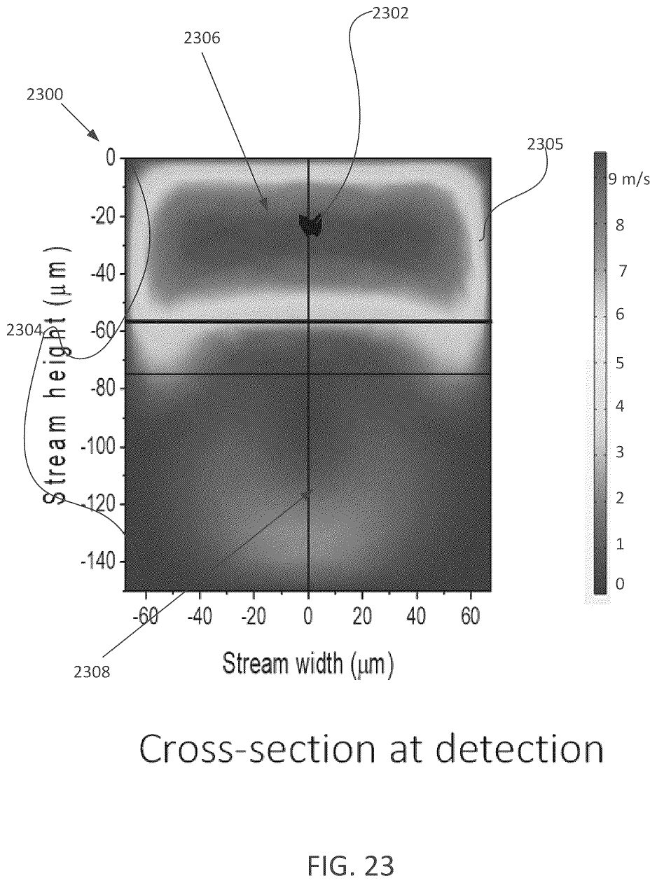

With reference now to FIG. 23, the velocity profile for fluid flows within the microfluidic channel structure 10 and the simulated position of particles 2302 within the fluid flow at the interrogation region 600 is provided. The graphs of the velocity profile 2300 shown in FIG. 23 represents the flow conditions at the interrogation and action region in the interrogation region 600, such as shown between microweirs 610 and 620 in FIG. 22.

In the velocity magnitude graph 2300, it can be seen that the magnitude of velocity of the fluid flow within the channel increases inwardly towards the center of the channel with the velocity being near 0 m/s at the edges and greater than 9 m/s towards the center of the channel. It can also be appreciated that there is a gradient of velocity that increases towards the center of the channel. The relative size and position of a sample stream 2302 is provided. The location of the stream is offset by 15-30 microns from atop surface, and approximately 0-5 microns from the centerline horizontally. The size of the stream is approximately 5-20 microns in width and height. The graph 2300 overlays the stream position shown in the graph with the velocity gradient shown. Areas of lower velocity 2304 (0-2 m/s) are shown near the edges of the rectangular channel, and an area of a medium velocity 2305 (approximately 5 m/s) separates the areas of lower velocity 2304 from the region of higher velocity 2306. The region wherein the vortex 2308 is disposed can be seen below the areas of medium 2305 and higher 2305 velocity and is surrounded by a region of lower velocity 2304. The effect of the relatively lower velocity regions 2304 and the vortex 2308 is to confine the area of higher velocity 2306 to the upper portion of the channel. This confines the sample fluid 2302 in the area of higher velocity 2306, causing the sample fluid to become and stay focused as it flows through the interrogation region 600.

In one embodiment, what is provided is a microweir structure for focusing a sample stream in a microfluidic chip, the microweir structure comprising: a curvilinear structure extending widthwise across a flow channel and extending upwards from a bottom surface of the flow channel without contacting a top surface of the flow channel and without completely obstructing the flow channel.

In various embodiments, a portion of the flow channel is 75 to 150 microns in width and 75 to 200 microns in height.

In various embodiments, a portion of the flow channel is 135 microns in width and 150 microns in height.

In various embodiments, a distance between a top of the curvilinear structure and the top surface of the flow channel is 40 to 75 microns.

In various embodiments, a distance between the top of the curvilinear structure and the top surface of the flow channel is 54.5 microns.

In various embodiments, a distance between the top of the curvilinear structure and the top surface of the flow channel is 47 microns.

In various embodiments, a distance between the top of the curvilinear structure and the top surface of the flow channel is 56.5 microns.

In various embodiments, a height of the curvilinear structure is 75 to 125 microns.

In various embodiments, the height of the curvilinear structure is 95.5 microns.

In various embodiments, the height of the curvilinear structure is 93.5 microns.

In various embodiments, the height of the curvilinear structure is 103 microns.

In various embodiments, the curvilinear structure is disposed in an interrogation region of the flow channel.

In various embodiments, the curvilinear structure is configured to focus a sample stream.

In various embodiments, the curvilinear structure is configured to orient particles suspended in a sample stream.

In various embodiments, the curvilinear structure comprises a set of curvilinear structures.

In various embodiments, an interrogation location is disposed between a first and a second curvilinear structure in the set of curvilinear structures.

In various embodiments, the first curvilinear structure in the set of curvilinear structures comprises an upstream curved portion, a top curved portion, and a downstream curved portion, and wherein the second curvilinear structure comprises only an upstream curved portion and a flat top portion.

In various embodiments, a distance between the first and the second curvilinear structures is between 300 and 500 microns.

In various embodiments, a distance between the first and the second curvilinear structures is 389 microns.

In various embodiments, a distance between the first and the second curvilinear structures is 407 microns.

In another embodiment, what is provided is a microweir structure for focusing a sample stream in a microfluidic chip, the microweir structure comprising: a substantially sinusoidal-shaped structure extending across a width of a flow channel, the substantially sinusoidal-shaped structure having an ascending portion, an apex, and a descending portion, the ascending portion extending upwardly from a bottom surface of the flow channel to the apex, the apex disposed at a point below a top surface of the flow channel, and the descending portion extending downwardly from the apex to the bottom surface of the flow channel, wherein a vertex defining the starting position of the ascending portion and a vertex defining an ending position of the descending portion are disposed on a same plane.

In another embodiment, what is provided is a microweir structure for focusing a sample stream in a microfluidic chip, the microweir structure comprising: a substantially derivative sigmoid-shaped structure extending across a width of a flow channel, the substantially derivative sigmoid-shaped structure having an ascending portion, an apex, and a descending portion, the ascending portion extending upwardly from a bottom surface of the flow channel to the apex, the apex disposed at a point below a top surface of the flow channel, and the descending portion extending downwardly from the apex to the bottom surface of the flow channel, wherein a vertex defining the starting position of the ascending portion and a vertex defining an ending position of the descending portion are disposed on a same plane.

In another embodiment, what is provided is a microweir structure for focusing a sample stream in a microfluidic chip, the microweir structure comprising: a curved structure disposed on a bottom surface of a flow channel, wherein the structure extends from a first side to a second side of the flow channel and upwardly from a bottom surface of the flow channel, and wherein a shape of the curved structure at a longitudinal cross-section is defined by the formula

$$y = \frac{1}{\sqrt[σ]{2 π}} {e}^{- \frac{{( x - μ )}^{2}}{2 {σ}^{2}}} .$$

In another embodiment, what is provided is a microweir structure for focusing a sample stream in a microfluidic chip, the microweir structure comprising: a curved structure disposed on a bottom surface of a flow channel, wherein the structure extends from a first side to a second side of the flow channel and upwardly from a bottom surface of the flow channel, and wherein a shape of the curved structure at a longitudinal cross-section is defined by the formula y=e^{-x}^{²}.

In another embodiment, what is provided is a microweir structure for focusing a sample stream in a microfluidic chip, the microweir structure comprising: a curved structure disposed on a bottom surface of a flow channel, wherein the structure extends from a first side to a second side of the flow channel and upwardly from a bottom surface of the flow channel, and wherein a shape of the curved structure at a longitudinal cross-section is defined by the formula

$$\frac{{e}^{- x}}{{( 1 + {e}^{- x} )}^{2}} .$$

In another embodiment, what is provided is a microweir structure for focusing a sample stream in a microfluidic chip, the microweir structure comprising: a curved structure disposed on a bottom surface of a flow channel, wherein the structure extends from a first side to a second side of the flow channel and upwardly from a bottom surface of the flow channel; wherein a curvature of an upstream surface of the curved structure is defined by a circle having a diameter of between 206 and 303 microns, a curvature of a downstream surface of the curved structure is defined by a circle having a diameter of between 206 and 303 microns, and a top of the curved structure disposed between the upstream surface and the downstream surface is a curved surface defined by a circle having a radius of 8 microns; and wherein a height of the curved structure is between 70 and 110 microns.

In another embodiment, what is provided is a method of focusing a sample fluid stream in a microfluidic channel comprising: introducing the sample fluid stream in a flow channel; introducing a sheath fluid stream in the flow channel and surrounding the sample fluid stream in the sheath fluid stream; flowing the sample fluid stream over a microweir structure, wherein the sample fluid stream is focused vertically in at least one direction by flowing over the microweir structure, and wherein a flow vortex downstream of the microweir structure maintains focusing of the sample stream downstream of the microweir structure.

In various embodiments, a portion of the flow channel is 75 to 150 microns in width and 75 to 200 microns in height.

In various embodiments, a portion of the flow channel is 135 microns in width and 150 microns in height.

In various embodiments, a distance between a top of the microweir structure and the top surface of the flow channel is 40 to 75 microns.

In various embodiments, a distance between the top of the microweir structure and the top surface of the flow channel is 54.5 microns.

In various embodiments, a distance between the top of the microweir structure and the top surface of the flow channel is 47 microns.

In various embodiments, a distance between the top of the microweir structure and the top surface of the flow channel is 56.5 microns.

In various embodiments, a height of the microweir structure is 75 to 125 microns.

In various embodiments, the height of the microweir structure is 95.5 microns.

In various embodiments, the height of the microweir structure is 93.5 microns.

In various embodiments, the height of the microweir structure is 103 microns.

In various embodiments, the microweir structure is disposed in an interrogation region of the flow channel.

In various embodiments, the microweir structure is configured to focus a sample stream.

In various embodiments, the microweir structure is configured to orient particles suspended in a sample stream.

In various embodiments, the microweir structure comprises a set of microweir structures.

In various embodiments, an interrogation location is disposed between a first and a second microweir structure in the set of microweir structures.

In various embodiments, the first microweir structure in the set of microweir structures comprises an upstream curved portion, a top curved portion, and a downstream curved portion, and wherein the second microweir structure comprises only an upstream curved portion and a flat top portion.

In various embodiments, a distance between the first and the second microweir structures is between 300 and 500 microns.

In various embodiments, a distance between the first and the second microweir structures is 389 microns.

In various embodiments, a distance between the first and the second microweir structures is 407 microns.

In another embodiment, what is provided is a set of microweir structures for focusing a sample stream in a microfluidic chip, the set of microweir structures comprising: a first microweir structure comprising a substantially sinusoidal-shaped structure extending across a width of a flow channel, the ramp structure having an ascending portion, an apex, and a descending portion, the ascending portion extending upwardly from a bottom surface of the flow channel to the apex, the apex disposed at a point below a top surface of the flow channel, and the descending portion extending downwardly from the apex to the bottom surface of the flow channel, wherein a vertex defining the starting position of the ascending portion and a vertex defining an ending position of the descending portion are disposed on a same plane; and a second microweir structure comprising a substantially sinusoidal-shaped structure extending across a width of a flow channel, the ramp structure having an ascending portion, an apex, and a descending portion, the ascending portion extending upwardly from a bottom surface of the flow channel to the apex, the apex disposed at a point below a top surface of the flow channel, and the descending portion extending downwardly from the apex to the bottom surface of the flow channel, wherein a vertex defining the starting position of the ascending portion and a vertex defining an ending position of the descending portion are disposed on a same plane.

In another embodiment, what is provided is a microfluidic channel structure comprising: a sheath fluid channel; a sample fluid channel; an intersection; and a flow channel comprising at least one microweir structure, the microweir structure comprising a curvilinear structure extending widthwise across the flow channel and extending upwards from a bottom surface of the flow channel without contacting a top surface of the flow channel and without completely obstructing the flow channel; wherein the sample fluid channel and the sheath fluid channel are substantially disposed upstream of the intersection and intersect at the intersection; and wherein the flow channel is disposed substantially downstream of the intersection.

In another embodiment, what is provided is a microfluidic chip comprising: a microfluidic channel structure, the microfluidic channel structure comprising a curvilinear structure extending widthwise across a flow channel in the microfluidic chip and extending upwards from a bottom surface of the flow channel without contacting a top surface of the flow channel and without completely obstructing the flow channel.

In another embodiment, what is provided is a system for differentiating particles in a sample stream, the system comprising: an interrogation means; a detection means; and a microfluidic chip comprising a microfluidic channel structure, the microfluidic channel structure comprising a curvilinear structure extending widthwise across a flow channel in the microfluidic chip and extending upwards from a bottom surface of the flow channel without contacting a top surface of the flow channel and without completely obstructing the flow channel, the curvilinear structure configured to focus a sample stream in the microfluidic channel for interrogation and detection by the respective detection means and interrogation means.

In another embodiment, what is provided is a method of focusing a sample stream, the method comprising: providing a sample stream in a microfluidic channel structure of a microfluidic chip; providing a buffer fluid stream in the microfluidic channel structure of the microfluidic chip; flowing the sample fluid stream and the buffer fluid stream through the microfluidic channel structure of the microfluidic chip in a laminar flow to an interrogation region; and prior to the interrogation region, focusing the sample fluid stream by at least one microweir structure.

In another embodiment, what is provided is a method of orienting particles in a sample stream, the method comprising: providing a sample stream in a microfluidic channel structure of a microfluidic chip; providing a buffer fluid stream in the microfluidic channel structure of the microfluidic chip; flowing the sample fluid stream and the buffer fluid stream through the microfluidic channel structure of the microfluidic chip in a laminar flow to an interrogation region; and prior to the interrogation region, orienting particles suspended in the sample fluid stream by positioning the sample fluid stream near a top surface of the microfluidic channel structure using at least one microweir structure.

In one embodiment, a flow cytometry system is provided which comprises an interrogation apparatus. Although a laser may be used, it is understood that other suitable radiation sources may be used, such as a light emitting diode (LED), arc lamp, etc. to emit a beam which excites the particles. In another embodiment, the light beam can be delivered to the particles by an optical fiber that is embedded in the microfluidic chip at the opening.

In some embodiments, a high intensity laser beam from a suitable laser of a preselected wavelength—such as a 355 nm continuous wave (CW) (or quasi-CW) laser, or a 355 nm pulse laser—is required to excite the particles in the fluid mixture (i.e., sperm cells). The laser emits a laser beam through the window so as to illuminate the particles flowing through the interrogation region of the chip. Since the laser beam can vary in intensity widthwise along the micro-channel, with the highest intensity generally at the center of the flow channel (e.g., midsection of the channel width) and decreasing therefrom, it is imperative that the microfluidic channel structure, including the intersection, focuses the particles at or near the center of the fluid stream where optimal illumination occurs at or near the center of the illumination laser spot. Without wishing to be bound to a particular belief, this can improve accuracy of the interrogation and identification process.

In some embodiments, the high intensity beam interacts with the particles such that the emitted light, which is induced by the beam, is received by an objective lens. The objective lens may be disposed in any suitable position with respect to the microfluidic chip. In one embodiment, the emitted light received by the objective lens is converted into an electronic signal by an optical sensor, such as a photomultiplier tube (PMT) or photodiode, etc. The electronic signal can be digitized by an analog-to-digital converter (ADC) and sent to a digital signal processor (DSP) based controller. The DSP based controller monitors the electronic signal and may then trigger a sorting mechanism.

In other embodiments, the interrogation apparatus may comprise a detector such as a photomultiplier tube (PMT), an avalanche photodiode (APD), or a silicon photomultiplier (SiPM). For example, the optical sensor of the interrogation apparatus may be APD, which is a photodiode with substantial internal signal amplification through an avalanche process.

In some embodiments, a piezoelectric actuator assembly may be used to sort the desired particles in the fluid mixture as the particles leave the interrogation area after interrogation. A trigger signal sent to the piezoelectric actuator is determined by the sensor raw signal to activate a particular piezoelectric actuator assembly when the selected component is detected. In some embodiments, a flexible diaphragm made from a suitable material, such as one of stainless steel, brass, titanium, nickel alloy, polymer, or other suitable material with desired elastic response, is used in conjunction with an actuator to push target particles in the micro-channel into an output channel to isolate the target particles from the fluid mixture. The actuator may be a piezoelectric, magnetic, electrostatic, hydraulic, or pneumatic type actuator.

In alternative embodiments, a piezoelectric actuator assembly or a suitable pumping system may be used to pump the sample fluid into the sample fluid channel toward the intersection. The sample piezoelectric actuator assembly may be disposed at a sample inlet. By pumping the sample fluid mixture into the flow channel, a measure of control can be made over the spacing of the particles therein, such that a more controlled relationship may be made between the particles as they enter the flow channel.

Other embodiments of sorting or separating mechanisms that may be used in accordance with the present invention include, but are not limited to, droplet sorters, mechanical separation, fluid switching, acoustic focusing, holographic trapping/steering, and photonic pressure/steering. In a preferred embodiment, the sorting mechanism for sex-sorting of sperm cells comprises laser kill/ablation of selected X-chromosome-bearing sperm cells.

In laser ablation, the laser is activated when an X-chromosome-bearing sperm cell or Y-chromosome-bearing sperm cell is detected during interrogation, depending on which cell type the system is selecting or enriching for. The laser emits a high intensity beam directed at the sperm cell centered within the fluid stream. The high intensity beam is configured to cause DNA and/or membrane damage to the cell, such as by slicing or ablating the cell, thereby causing infertility or killing the sperm cell. As a result, the final product is comprised predominantly of viable X-chromosome-bearing sperm cells or Y-chromosome-bearing sperm cells depending on which cell type the system is selecting or enriching for. In preferred embodiments, a reduction in the cross-sectional area, either vertically, horizontally, or both, of the flow focusing region geometrically compresses the fluid that carries sperm cells. The geometric compression of the fluid centralizes the sperm cells within the fluid such that the sperm cells are focused at or near a center of the flow channel. This may be used in addition to hydrodynamic focusing by the introduction of sheath fluid. Since the laser beam varies in intensity widthwise along the flow channel, with the highest intensity generally at the center of the flow channel and decreasing therefrom, it is imperative that the microfluidic channel structure focuses the sperm cells at or near the center of the fluid stream where the laser beam has the highest intensity to impart maximum damage to the selected sperm cells.

In one embodiment, the particles that are to be isolated, selected, or enriched for include, for example: isolating viable and motile sperm from non-viable or non-motile sperm; isolating sperm by gender, and other sex sorting variations; isolating stem cells from cells in a population; isolating one or more labeled cells from un-labeled cells distinguishing desirable/undesirable traits; sperm cells with different desirable characteristics; isolating genes in nuclear DNA according to a specified characteristic; isolating cells based on surface markers; isolating cells based on membrane integrity (viability), potential or predicted reproductive status (fertility), ability to survive freezing, etc.; isolating cells from contaminants or debris; isolating healthy cells from damaged cells (i.e., cancerous cells) (as in bone marrow extractions); red blood cells from white blood cells and platelets in a plasma mixture; and isolating any cells from any other cellular components, into corresponding fractions; damaged cells, or contaminants or debris, or any other biological materials that are desired to isolated. The particles may be cells or beads treated or coated with, linker molecules, or embedded with a fluorescent or luminescent label molecule(s). The particles may have a variety of physical or chemical attributes, such as size, shape, materials, texture, etc.

In one embodiment, a heterogeneous population of particles may be measured simultaneously, with each component being examined for different quantities or regimes in similar quantities (e.g., multiplexed measurements), or the particles may be examined and distinguished based on a label (e.g., fluorescent), image (due to size, shape, different absorption, scattering, fluorescence, luminescence characteristics, fluorescence or luminescence emission profiles, fluorescent or luminescent decay lifetime), and/or particle position etc.

In one embodiment, a focusing method may be used in order to position the particles for interrogation in the interrogation region. In some embodiments, the particles are pre-stained with dye (e.g., Hoechst dye), in order to allow fluorescence, and for imaging to be detected. Initially, the particles in the sample fluid mixture flow through sample channel and have random orientation and position. At the intersection, the sample mixture flowing in the flow channel is compressed by the sheath or buffer fluids flowing from the sheath channel structure at least horizontally on at least both sides of the flow, and at least vertically on at least both sides of the flow. As a result, the particles are focused and compressed into a thin stream and the particles (e.g., sperm cells) move approximately toward a center of the channel width.

In another embodiment, what is provided are additional geometric focusing or constricting steps where the sample mixture containing the particles is further compressed, at least horizontally, downstream of the intersection. This comprises physical or geometric compression instead of another intersection of sheath fluids. In preferred embodiments, the particles are flowing in approximately single file formation, and in other embodiments the particles are flowing in approximately single file formation with regulated or regular spacing.

Accordingly, the microfluidic chip and microfluidic channel structure described herein may be used in the focusing method described above. In one embodiment, the present invention provides a method of focusing particles in a fluid flow.

Compression of the fluid mixture, by the introduction of sheath fluid and/or the physical structures at the constricting and focusing regions constricts the particles of the fluid mixture into a relatively smaller, narrower stream bounded by the sheath fluids. For example, sheath fluid compresses the sample fluid stream from all sides into a relatively smaller, narrower stream while maintaining laminar flow. Flow of the sample fluid and sheath fluids in the intersection causes further constriction of the sample fluid stream and re-orienting of the particles within the stream, which is caused by the introduction of sheath fluid from both sides, thus focusing the particles.

In some embodiments, the particles in the sample fluid are sperm cells, and because of their pancake-type or flattened teardrop shaped head, the sperm cells can re-orient themselves in a predetermined direction as they undergo focusing—i.e., with their flat surfaces perpendicular to the direction of a light beam. Thus, the sperm cells develop a preference on their body orientation while passing through the two-step focusing process. Specifically, the sperm cells tend to be more stable with their flat bodies perpendicular to the direction of the compression. The sperm cells which start with random orientation achieve uniform orientation of approximately 90-99%, such as at least 91%, at least 92%, at least 93%, at least 94%, at least 95%, at least 96%, at least 97%, at least 98%, or at least 99%. The sperm cells not only make a single file formation at the center of the channel, but they also achieve a near uniform orientation. Thus, the particles introduced into sample input, which may be other types of cells or other materials as previously described, undergo focusing, which orients and positions the particles in a single file formation, and in a more uniform orientation (depending on the type of particles), which allows for easier interrogation of the particles.

In addition to and/or in conjunction with the other embodiments recited herein, the present invention also provides a method of producing a fluid with gender-skewed sperm cells. The method may comprise providing any one of the microfluidic devices described herein, such that the sheath fluid causes laminar flow and compresses the semen fluid from all sides, wherein the semen fluid becomes surrounded by sheath fluid and compressed into a thin stream, flowing the semen fluid and sheath fluids into the downstream flow channel, determining a chromosome type of the sperm cells in the semen fluid stream, wherein each sperm cell is either a Y-chromosome-bearing sperm cell or an X-chromosome-bearing sperm cell, and sorting Y-chromosome-bearing sperm cells from X-chromosome-bearing sperm cells or vice versa, thereby producing the fluid comprising gender-skewed sperm cells that are predominantly Y-chromosome-bearing or X-chromosome-bearing sperm cells.

In some embodiments, the chromosome type of the sperm cells may be determined using any one of the interrogation apparatus, devices, or methods described herein. In one embodiment, the microfluidic chip may further comprise an interrogation region downstream of the intersection. An interrogation apparatus coupled to the interrogation region is used to determine the chromosome type of the sperm cells and sort said sperm cells based on chromosome type. The interrogation apparatus may comprise a radiation source that illuminates and excites the sperm cells, and a response of the sperm cell is indicative of the chromosome type in the sperm cell. The response of the sperm cell may be detected by an optical sensor. In other embodiments, the interrogation apparatus may further comprise a laser source. The Y-chromosome-bearing sperm cells are sorted from the X-chromosome-bearing sperm cells or the X-chromosome-bearing sperm cells are sorted from the Y-chromosome-bearing sperm cells by laser ablation, which exposes the cells to the high intensity laser source that damages or kills cells that are determined to bear an X-chromosome or a Y-chromosome, depending on the characteristic or feature being enriched or selected for. In one embodiment, the gender-skewed sperm cells are comprised of at least 55% of Y-chromosome-bearing sperm cells. In another embodiment, the gender-skewed sperm cells are comprised of about 55%-99% of Y-chromosome-bearing sperm cells. In yet another embodiment, the gender-skewed sperm cells are comprised of at least 90%, at least 91%, at least 92%, at least 93%, at least 94%, at least 95%, or at least 96% of Y-chromosome-bearing sperm cells. In yet another embodiment, the gender-skewed sperm cells are comprised of at least 99% of Y-chromosome-bearing sperm cells. In one embodiment, the gender-skewed sperm cells are comprised of at least 55% of X-chromosome-bearing sperm cells. In another embodiment, the gender-skewed sperm cells are comprised of about 55%-99% of X-chromosome-bearing sperm cells. In yet another embodiment, the gender-skewed sperm cells are comprised of at least 90%, at least 91%, at least 92%, at least 93%, at least 94%, at least 95%, or at least 96% of X-chromosome-bearing sperm cells. In yet another embodiment, the gender-skewed sperm cells are comprised of at least 99% of X-chromosome-bearing sperm cells.

In one embodiment, the particles are detected in the interrogation chamber using a radiation source. The radiation source emits a light beam (which may be via an optical fiber) which is focused at the center of the channel widthwise. In one embodiment, the particles, such as sperm cells, are oriented by the focusing and/or proximity to a surface such that the flat surfaces of the particles are facing toward the beam. In addition, all particles are aligned in a substantially single file formation by focusing as they pass under a radiation source. As the particles pass under the radiation source and are acted upon by a light beam, the particles emit the fluorescence, which may be a Stoke shifted emission, which indicates the desired particles. For example, with respect to sperm cells, X chromosome cells fluoresce at a different intensity from Y chromosome cells; or cells carrying one trait may fluoresce in a different intensity or wavelength from cells carrying a different set of traits. In addition, the particles can be viewed for shape, size, or any other distinguishing indicators.

In one embodiment, interrogation of the sample containing particles (i.e., biological material), is accomplished by other methods. Overall, methods for interrogation may include direct visual imaging, such as with a camera, and may utilize direct bright-light imaging or fluorescent imaging; or, more sophisticated techniques may be used such as spectroscopy, transmission spectroscopy, spectral imaging, or scattering such as dynamic light scattering or diffusive wave spectroscopy. In some cases, the optical interrogation region may be used in conjunction with additives, such as chemicals which bind to or affect particles of the sample mixture or beads which are functionalized to bind and/or fluoresce in the presence of certain materials or diseases. These techniques may be used to measure cell concentrations, to detect disease, or to detect other parameters which characterize the particles.

However, in another embodiment, if fluorescence is not used, then polarized light back scattering methods may also be used. Using spectroscopic methods, the particles are interrogated and the spectrum of those particles which had positive results and fluoresced (i.e., those particles which reacted with a label) are identified for separation. In some embodiments, the particles may be identified based on the reaction or binding of the particles with additives or sheath or buffer fluids, or by using the natural fluorescence of the particles, or the fluorescence of a substance associated with the component, as an identity tag or background tag, or met a selected size, dimension, or surface feature, etc., are selected for separation. In one embodiment, upon completion of an assay, selection may be made, via computer and/or operator, of which particles to discard and which to collect.

Continuing with the embodiment of beam-induced fluorescence, the emitted light beam is then collected by the objective lens, and subsequently converted to an electronic signal by the optical sensor. The electronic signal is then digitized by an analog-digital converter (ADC) and sent to an electronic controller for signal processing. The electronic controller can be any electronic processer with adequate processing power, such as a DSP, a Micro Controller Unit (MCU), a Field Programmable Gate Array (FPGA), or even a Central Processing Unit (CPU). In one embodiment, the DSP-based controller monitors the electronic signal and may then trigger a sorting mechanism when a desired component is detected. In another embodiment, the FPGA-based controller monitors the electronic signal and then either communicates with the DSP controller or acts independently to trigger a sorting mechanism when a desired component is detected. In some other embodiments, the optical sensor may be a photomultiplier tube (PMT), an avalanche photodiode (APD), or a silicon photomultiplier (SiPM). In a preferred embodiment, the optical sensor may be an APD that detects the response of the sperm cell to interrogation.

In one embodiment of the sorting mechanism, the selected or desired particles in the interrogation chamber are isolated into a desired output channel using a piezoelectric actuator. In an exemplary embodiment, the electronic signal activates the driver to trigger the actuator at the moment when the target or selected component arrives at a cross-section point of jet channels and the micro-channel. This causes the actuator to contact a diaphragm and push it, compressing a jet chamber, and squeezing a strong jet of buffer or sheath fluids into the micro-channel, which pushes the selected or desired component into a desired output channel.

In some embodiments, the isolated particles are collected from their respective output channel for storing, further separation, or processing, such as cryopreservation. In some embodiments, the outputted particles may be characterized electronically, to detect concentrations of particles, pH measuring, cell counts, electrolyte concentration, etc.

In some embodiments, the microfluidic chip may be loaded on a chip cassette, which is mounted on chip holder. The chip holder is mounted to a translation stage to allow fine positioning of the holder. For instance, the microfluidic chip holder is configured to hold the microfluidic chip in a pre-determined position such that the interrogating light beam intercepts the fluid particles. In one embodiment, the microfluidic chip holder is made of a suitable material, such as aluminum alloy, or other suitable metallic/polymer material. A main body of the holder may be any suitable shape, but its configuration depends on the layout of the chip. In further embodiments, the main body of the holder is configured to receive and engage with external tubing for communicating fluids/samples to the microfluidic chip. A gasket of any desired shape, or O-rings, may be provided to maintain a tight seal between the microfluidic chip and the microfluidic chip holder. The gasket may be a single sheet or a plurality of particles, in any configuration, or material (i.e., rubber, silicone, etc.) as desired. In one embodiment, the gasket interfaces, or is bonded (using an epoxy) with a layer of the microfluidic chip. The gasket is configured to assist in sealing, as well as stabilizing or balancing the microfluidic chip in the microfluidic chip holder. The details of the cassette and holder and the mechanisms for attachment of the chip to the cassette and holder, are not described in any detail, as one of ordinary skill in the art would know that these devices are well-known and may be of any configuration to accommodate the microfluidic chip, as long as the objectives of the present invention are met.

In some embodiments, a pumping mechanism includes a system having a pressurized gas which provides pressure for pumping sample fluid mixture from reservoir (i.e., sample tube) into sample input of the chip. In other embodiments, a collapsible container having sheath or buffer fluid therein, is disposed in a pressurized vessel, and the pressurized gas pushes fluid such that fluid is delivered via tubing to the sheath or buffer input of the chip.

In one embodiment, a pressure regulator regulates the pressure of gas within the reservoir, and another pressure regulator regulates the pressure of gas within the vessel. A mass flow regulator controls the fluid pumped via tubing, respectively, into the sheath or buffer input. Thus, tubing is used in the initial loading of the fluids into the chip, and may be used throughout the chip to load a sample fluid into sample input.

In accordance with the present invention, any of the operations, steps, control options, etc. may be implemented by instructions that are stored on a computer-readable medium such as a memory, database, etc. Upon execution of the instructions stored on the computer-readable medium, for example, by a computing device or processor, the instructions can cause the computing device or processor to perform any of the operations, steps, control options, etc. described herein. In some embodiments the operations described in this specification may be implemented as operations performed by a data processing apparatus or processing circuit on data stored on one or more computer-readable storage devices or received from other sources. A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data, in a single file dedicated to the program in question, or in multiple coordinated files. A program can be deployed to be executed on one computer or on multiple computers interconnected by a communication network. Processing circuits suitable for the execution of a computer program include, by way of example, both general and special purpose microprocessors, and any one or more processors of any kind of digital computer.

In one embodiment, a user interface of the computer system includes a computer screen which displays the particles in a field of view acquired by a CCD camera or other imaging sensor over the microfluidic chip. In another embodiment, the computer controls any external devices such as pumps, if used, to pump any sample fluids, sheath or buffer fluids into the microfluidic chip, and also controls any heating devices which set the temperature of the fluids being inputted into the microfluidic chip.

It should be noted that the orientation of various elements may differ according to other illustrative embodiments, and that such variations are intended to be encompassed by the present disclosure. The construction and arrangements of the microfluidic chip, as shown in the various illustrative embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various illustrative embodiments without departing from the scope of the present disclosure.

While the invention has been described by reference to certain preferred embodiments, it should be understood that numerous changes could be made within the spirit and scope of the inventive concept described. Also, the systems and methods herein are not to be limited in scope by the specific embodiments described herein. It is fully contemplated that other various embodiments of and modifications to the systems and methods herein, in addition to those described herein, will become apparent to those of ordinary skill in the art from the foregoing description and accompanying drawings. Thus, such other embodiments and modifications are intended to fall within the scope of the following appended claims. Further, although the systems and methods herein have been described herein in the context of particular embodiments and implementations and applications and in particular environments, those of ordinary skill in the art will appreciate that their usefulness are not limited thereto and that the present invention can be beneficially applied in any number of ways and environments for any number of purposes. Accordingly, the claims set forth below should be construed in view of the full breadth and spirit of the systems and methods as disclosed herein.

What is claimed is:

1) A microweir structure for focusing a sample stream in a microfluidic chip, the microweir structure comprising:
a curvilinear structure extending widthwise across a flow channel and extending upwards from a bottom surface of the flow channel without contacting a top surface of the flow channel and without completely obstructing the flow channel.

2) (canceled)

3) The microweir structure of claim 1, wherein the curvilinear structure is configured to focus a sample stream.

4) The microweir structure of claim 1, wherein the curvilinear structure is configured to orient particles suspended in a sample stream.

5) The microweir structure of claim 1, wherein the microweir structure comprises a set of curvilinear structures, and wherein the set of curvilinear structures includes the curvilinear structure.

6) The microweir structure of claim 5, wherein an interrogation or action region is disposed between a first and a second curvilinear structure in the set of curvilinear structures.

7) The microweir structure of claim 6, wherein the first curvilinear structure in the set of curvilinear structures comprises an upstream curved portion, a top curved portion, and a downstream curved portion, and wherein the second curvilinear structure consists essentially of an upstream curved portion and a flat top portion.

8) The microweir structure of claim 6, wherein a distance between the first and the second curvilinear structures is between 300 and 500 microns.

9) (canceled)

10) A method of focusing a sample fluid stream in a microfluidic channel comprising:
introducing the sample fluid stream in a flow channel;
introducing a sheath fluid stream in the flow channel and surrounding the sample fluid stream in the sheath fluid stream;
flowing the sample fluid stream over a microweir structure, wherein the sample fluid stream is focused vertically in at least one direction by flowing over the microweir structure, and wherein a flow vortex downstream of the microweir structure maintains focusing of the sample stream downstream of the microweir structure.

11) (canceled)

12) (canceled)

13) The method of claim 10, wherein a distance between a top of the microweir structure and the top surface of the flow channel is 40 to 75 microns.

14) The method of claim 13, wherein a height of the microweir structure is 75 to 125 microns.

15) (canceled)

16) (canceled)

17) (canceled)

18) The method of claim 10, wherein the microweir structure comprises a set of microweir structures.

19) The method of claim 18, wherein an interrogation or action region is disposed between a first and a second microweir structure in the set of microweir structures.

20) The method of claim 19, wherein the first microweir structure in the set of microweir structures comprises an upstream curved portion, a top curved portion, and a downstream curved portion, and wherein the second microweir structure consists essentially of an upstream curved portion and a flat top portion.

21) The method of claim 19, wherein a distance between the first and the second microweir structures is between 300 and 500 microns.

22) A set of microweir structures for focusing a sample stream in a microfluidic chip, the set of microweir structures comprising:
a first microweir structure comprising a first substantially sinusoidal-shaped structure extending across a width of a flow channel, the first substantially sinusoidal-shaped structure having an ascending portion, an apex, and a descending portion, the ascending portion extending upwardly from a bottom surface of the flow channel to the apex, the apex disposed at a point below a top surface of the flow channel, and the descending portion extending downwardly from the apex to the bottom surface of the flow channel, wherein a vertex defining the starting position of the ascending portion and a vertex defining an ending position of the descending portion are disposed on a same plane; and
a second microweir structure comprising a second substantially sinusoidal-shaped structure extending across the width of a flow channel, the second substantially sinusoidal-shaped structure having an ascending portion, an apex, and a descending portion, the ascending portion extending upwardly from the bottom surface of the flow channel to the apex, the apex disposed at a point below the top surface of the flow channel, and the descending portion extending downwardly from the apex to the bottom surface of the flow channel, wherein a vertex defining the starting position of the ascending portion and a vertex defining an ending position of the descending portion are disposed on a same plane.
